(19) United States
(12) Patent Application Publication
(10) Pub. No.: US 2024/0150635 A1
(43) Pub. Date: May 9, 2024

(54) SUNLIGHT-ACTIVATED PHASE CHANGE MATERIALS FOR CONTROLLED HEAT STORAGE AND TRIGGERED RELEASE

(71) Applicant: Brandeis University, Waltham, MA (US)

(72) Inventors: Grace GD Han, Belmont, MA (US); Yuran Shi, Waltham, MA (US)

(21) Appl. No.: 18/263,904

(22) PCT Filed: Feb. 2, 2022
(86) PCT No.: PCT/US2022/014950

§ 371 Date: Aug. 2, 2023

Related U.S. Application Data
(60) Provisional application No. 63/144,737, filed on Feb. 2, 2021.

(51) Int. Cl. C09K 5/06

(52) U.S. Cl. CPC C09K 5/063

(57) ABSTRACT

The present invention relates to a compound of Formula (I) where (II), (III), R₁, R₂, R₃, R₄, R₅, Q, and Z are as described herein and compositions containing this compound. The present invention also relates to a methods of making a compound of Formula (I) and methods of using one or more of these compounds as a thermal-storage material thermal-storage device and. Methods of storing energy are also described.

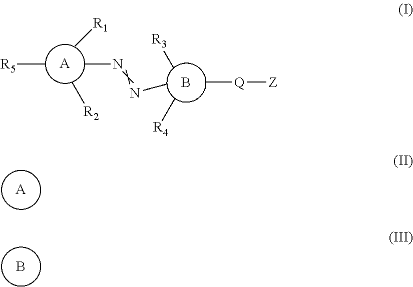

This application claims the benefit of U.S. Provisional Patent Application Ser. No. 63/144,737, filed Feb. 2, 2021, which is hereby incorporated by reference in its entirety.

This invention was made with government support from the National Science Foundation under grant DMR-2011846. The U.S. government has certain rights in this invention.

### FIELD OF THE INVENTION

The present invention relates to sunlight-activated phase change materials for controlled heat storage and triggered release.

### BACKGROUND OF THE INVENTION

Photo-induced molecular transformations, either photo-chemical reactions (Yoon, “Photochemical Stereocontrol Using Tandem Photoredox—Chiral Lewis Acid Catalysis,” Acc. Chem. Res. 49:2307-2315 (2016); Brimioulle et al., “Enantioselective Catalysis of Photochemical Reactions,” Angew. Chem. Int. Ed. 54:3872-3890 (2015); Hoffmann, “Photochemical Reactions as Key Steps in Organic Synthesis,” Chem. Rev. 108:1052-1103 (2008); Tong et al., “Photomechanical Molecular Crystals and Nanowire Assemblies Based on the [2+2] Photodimerization of a Phenylbutadiene Derivative,” J. Mater. Chem. C 8:5036-5044 (2020)) or reversible photo-mechanical isomerizations (Chen et al., “Entangled Azobenzene-Containing Polymers with Photoinduced Reversible Solid-to-Liquid Transitions for Healable and Reprocessable Photoactuators,” Adv. Funct. Mater. 30:1906752 (2020); Nguyen et al., “ An Arylazopyrazole-Based N-Heterocyclic Carbene as a Photoswitch on Gold Surfaces: Light-Switchable Wettability, Work Function, and Conductance,” Angew. Chem. Int. Ed. 59:13651-13656 (2020); Nie et al., “Light-Controllable Ionic Conductivity in a Polymeric Ionic Liquid,” Angew. Chem. Int. Ed. 59:5123-5128 (2020); Hanopolskyi et al., “Reversible Switching of Arylazopyrazole within a Metal—Organic Cage,” Beilstein J. Org. Chem. 15:2398-2407 (2019); Heindl et al., “Starazo Triple Switches—Synthesis of Unsymmetrical 1,3,5-Tris(arylazo)benzenes,” Beilstein J. Org. Chem. 16:22-31 (2020); Rice et al., “Photophysics Modulation in Photoswitchable Metal—Organic Frameworks,” Chem. Rev. 120:8790-8813 (2020); Heindl et al., “Rational Design of Azothiophenes—Substitution Effects on the Switching Properties,” Chem. Eur. J. 26:13730-13737 (2020); Hou et al., “Engineering Optically Switchable Transistors With Improved Performance by Controlling Interactions of Diarylethenes in Polymer Matrices,” J. Am. Chem. Soc. 142:11050-11059 (2020); Klaue et al., “Donor-Acceptor Dihydropyrenes Switchable with Near-Infrared Light,” J. Am. Chem. Soc. 142:11857-11864 (2020); Lentes et al., “Nitrogen Bridged Diazocines: Photochromes Switching within the Near-Infrared Region With High Quantum Yields in Organic Solvents and in Water,” J. Am. Chem. Soc. 141:13592-13600 (2019); Seshadri et al., “Self-Regulating Photochemical Rayleigh-Benard Convection Using a Highly-Absorbing Organic Photoswitch,” Nat. Commun. 11:2599 (2020)), have attracted a significant attention as a potential chemical method for harnessing solar energy. A particular class of molecules, called molecular solar thermal storage (MOST) systems (Orrego-Hernandez et al., “Engineering of Norbornadiene/Quadricyclane Photoswitches for Molecular Solar Thermal Energy Storage Applications,” Acc. Chem. Res. 53:1478-1487 (2020); Wang et al., “Evaluating Dihydroazulene/Vinylheptafulvene Photoswitches for Solar Energy Storage Applications,” ChemSusChem 1:3049-3055 (2017); Wang et al., “Demonstration of an Azobenzene Derivative Based Solar Thermal Energy Storage System,” J. Mater. Chem. A 7:15042-15047 (2019)), that respond to light by conformational and energetic changes present an exciting opportunity to store photon energy in constrained chemical bonds and release the energy upon triggering in the form of heat. The absence of byproducts, the capability of isomerizing in condensed phases (i.e. solid and liquid), and recyclability are unique characteristics of the MOST systems, which indicates the potential of applying the molecular systems for a thermal battery. However, the low energy storage density of common MOST compounds, particularly azobenzene derivatives, in the range of —41 kJ/mol for pristine (Corruccini et al., “The Heat of Combustion of Cis- and Trans-Azobenzene,” J. Am. Chem. Soc. 61:2925-2927 (1939)), presented a challenge for achieving a high-density thermal energy storage for practical applications.

Among various strategies to address this challenge, the promotion of simultaneous isomerization and phase transition between solid and liquid demonstrated to enhance the total energy storage in MOST systems. Many material systems including ionic crystals (Ishiba et al., “Photoliquefiable Ionic Crystals: A Phase Crossover Approach for Photon Energy Storage Materials With Functional Multiplicity,” Angew. Chem., Int. Ed. 54:1532-1536 (2015)), self-assembling structures (Han et al., “Photon Energy Storage Materials With High Energy Densities Based on Diacetylene—Azobenzene Derivatives,” J. Mater. Chem. A 4:16157-16165 (2016)), and polymers (Zhou et al., “Photoswitching of Glass Transition Temperatures of Azobenzene-Containing Polymers Induces Reversible Solid-to-Liquid Transitions,” Nat. Chem. 9:145-151 (2017); Saydjari et al., “Spanning the Solar Spectrum: Azopolymer Solar Thermal Fuels for Simultaneous UV and Visible Light Storage,” Adv. Energy Mater. 7:1601622 (2017); Kuenstler et al., “Reversible Actuation via Photoisomerization-Induced Melting of a Semicrystalline Poly(Azobenzene),” ACS Macro Lett. 9:902-909 (2020)) that incorporate azobenzene switches showed the solid-to-liquid transition while a photo-switch transforms from a planar isomer to a non-planar counterpart (Xu et al., “Photoinduced Reversible Solid-to-Liquid Transitions for Photoswitchable Materials,” Angew. Chem. Int. Ed. 58:9712-9740 (2019)). More recently, azobenzenes or arylazopyrazoles decorated with phase transition-directing alkyl chains manifested both the photon energy storage through E-Z isomerization and the latent heat storage via concomitant melting, followed by the preservation of Z liquid phase in dark (Zhang et al., “Photochemical Phase Transitions Enable Coharvesting of Photon Energy and Ambient Heat for Energetic Molecular Solar Thermal Batteries That Upgrade Thermal Energy,” J. Am. Chem. Soc. 142:12256-12264 (2020); Gerkman et al., “Arylazopyrazoles for Long-Term Thermal Energy Storage and Optically Triggered Heat Release below 0° C.,” J. Am. Chem. Soc. 142:8688-8695 (2020); Han et al., “Optically-Regulated Thermal Energy Storage in Diverse Organic Phase-Change Materials,” Chem. Commun. 54:10722-10725 (2018)). Arylazopyrazoles, in particular, show substantial energy densities (i.e. 0.17-0.24 MJ/kg) (Gerkman et al., “Toward Controlled Thermal Energy Storage and Release in Organic Phase Change Materials,” Joule 4:1621-1625 (2020)), which is comparable to the specific energy density of Li ion batteries (i.e. 0.36-0.72 MJ/kg) (Tarascon et al., “Issues and Challenges Facing Rechargeable Lithium Batteries,” Nature 414:359-367 (2001)), as a result of the combined storage of isomerization energy and heat of fusion. Also, the liquid phase acquired by E-to-Z switching presents an outstanding energy storage time (i.e., a few weeks) under various storage conditions such as subzero temperatures. This is achieved by the enhanced intramolecular interactions within Z isomers of arylazopyrazoles, which increases the stability of the metastable liquid phase.

All of the aforementioned molecular systems, however, share a critical limitation: the E-to-Z switching requires a strong UV irradiation for promoting π-π* transition, which precludes the photo-activation of MOST systems by direct sunlight. The visible light photons, a major part of solar spectrum, induce Z-to-E reversion of switches, establishing a low % Z in the compounds at the photostationary state. Due to the small fraction of UV photons in the solar spectrum, the usage of UV band-pass filters significantly reduces the total irradiance of incident light, resulting in the insufficient E-to-Z conversion. Fortunately, the ortho-functionalization of azobenzene moiety with fluorine (Knie et al., “Ortho-Fluoroazobenzenes: Visible Light Switches with Very Long-Lived Z Isomers,” Chem. Eur. J. 20:16492-16501 (2014)), methoxy (Beharry et al., “Azobenzene Photoswitching Without Ultraviolet Light,” J. Am. Chem. Soc. 133:19684-19687 (2011); Samanta et al., “Photoswitching Azo Compounds in Vivo with Red Light,” J. Am. Chem. Soc. 135:9777-9784 (2013)), and mixed halogen groups (Konrad et al., “Computational Design and Synthesis of a Deeply Red-Shifted and Bistable Azobenzene,” J. Am. Chem. Soc. 142:6538-6547 (2020)) have been recently reported to successfully red-shift the n-π* band of E isomers via the intramolecular interaction between the N═N group and the ortho-functional groups. The syntheses and solution-state characterizations of such switches have been comprehensively investigated, while the utilization of their remarkable optical properties for the direct harnessing of solar photon and heat has yet to be realized.

The present invention is directed to overcoming these and other deficiencies in the art.

### SUMMARY OF THE INVENTION

A first aspect of the present application relates to a compound of Formula (I):

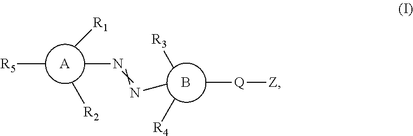

wherein
[symbol] and [symbol] are independently aryl or heteroaryl 5- or 6-membered rings;
R¹, R², R³, and R⁴ are each in an ortho position to the azo group, and each is independently selected from halogen, C₁ to C₆ alkoxy, C₁ to C₆ alkylthio, halomethyl, dihalomethyl, trihalomethyl, and di(C₁ to C₆ alkyl)amino;
R⁵ is H, C₁ to C₆ alkyl, C₁ to C₆ alkoxy, halogen, trihalomethyl, or cyano;
Q is X is —OC(O)—, —OC(S)—, —NHC(O)—, —SC(O)—, —NHC(S)—, —NHC(O)NH—, —NHC(S)NH—, —C(O)NHC(O)—; and
Z is a C₆ to C₁₈ straight- or branched-chain hydrocarbon.

According to one embodiment of this first aspect, the compound has the structure of Formula (Ia):

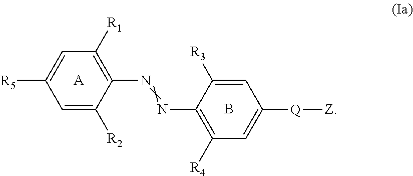

A second aspect of the present application relates to a composition comprising one or more compounds of Formula (I) or (Ia) according to the first aspect of the application.

A third aspect of the present application relates to a process for preparation of a compound of Formula (I) or (Ia) according to the first aspect of the application.

According to one embodiment, where Q is —OC(O)— or —OC(S)—, the process includes the steps of providing a compound of Formula (II) or (IIa):

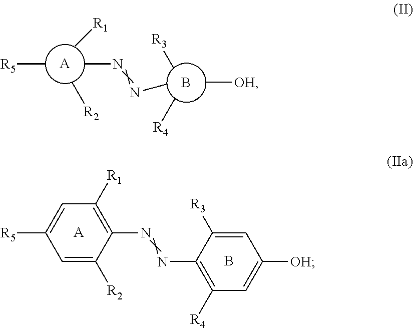

and reacting the compound of formula (II) or (IIa) with

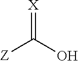

under conditions effective to form the compound according to formula (I) or (Ia).

A fourth aspect of the present application relates to a use of one or more compounds of Formula (I) or (Ia) according to the first aspect of the application, or a composition according to the second aspect of the application as a thermal-storage material.

A fifth aspect of the present application relates to a composite structure that includes a compound of Formula (I) or (Ia) according to the first aspect of the application, or a composition according to the second aspect of the application.

In one embodiment, the composite structure includes a porous structural component and a compound or a composition as disclosed herein.

In another embodiment, the composite structure includes an enclosure that comprises an optically transparent wall and defines a compartment comprising a compound or a composition as disclosed herein.

A sixth aspect of the present application relates to a thermal-storage device that includes a compound or a composition as disclosed herein, where the one or more compounds or the composition is retained on a substrate.

A seventh aspect of the present application relates to a method of storing energy. This method includes the steps of: providing an energy storage device comprising one or more compounds according to the first aspect of the application, or a composition according to the second aspect of the application, whereby the one or compounds of Formula (I) or (Ia) is present as an E-isomer; activating the compounds of Formula (I) or (Ia) to produce a Z-isomer of the one or more compounds according to Formula (I) or (Ia); and storing the Z-isomer of the one or more compounds of Formula (I) or (Ia) for a period of time. Following storage, the Z-isomer can be induced to revert to the E-isomer, resulting in the exothermic release of the stored energy. The heat can be used for various end purposes (e.g., warming a particular environment, another component, or an individual).

Photo-responsive organic phase change materials that absorb solar irradiation to store both latent heat and photon energy via simultaneous phase transition and photo-isomerization were designed. The activation of photo-switches by long wavelengths 530 nm in the visible light range at a low irradiance was achieved by the ortho-substitution of azobenzene units, and the facile transition from crystalline to liquid phase was enabled by appending an aliphatic group on the photochromic moiety. The sunlight-activated liquid phase exhibited an exceptionally long heat storage time over a month, and the release of energy was triggered by a short irradiation at 430 nm. The successful demonstration of photo-controlled latent heat storage accomplished by solar irradiation opens a new horizon on solar energy harvesting by functional organic materials, as a complementary system to photocatalysts and photovoltaic materials.

The present application provides a first demonstration of spontaneous solar activation of azobenzene derivatives that undergo the simultaneous phase transition from solid to liquid and the isomerization from E to Z structures. Various ortho-functionalized azobenzene derivatives showed the significantly red-shifted n-π* absorption, which allowed for the efficient E-to-Z switching under filtered sunlight without the need for any external UV light sources. The appended tridecanoate and ethylhexanoate groups along with the ortho-substituents played an important role in reducing the melting points of the compounds and accomplishing the solid-to-liquid phase transition under the direct sunlight during the photo-switching process. The liquid phase of Z isomers exhibited an exceptional stability under a wide range of temperatures, −40° C. to 110° C., successfully storing the latent heat and photon energy for over a month, until the specific optical triggering led to the immediate crystallization and release of heat. This new generation of optically-controlled phase change materials will facilitate the harvesting and storage of solar energy in a large quantity.

The accompanying examples demonstrate a number of unique and surprising properties. The filtered sunlight-induced E-to-Z conversion and high photostationary state (PSS) Z% that are unique to these compounds. The high conversion rates achieved at a low intensity of light (51-52% conversion obtained by unfiltered sunlight irradiation, compound 1 and 3) were unexpected. The experiments of converting switches with either unfiltered or filtered sunlight are not believed to have been conducted previously. The method of using natural sunlight and a greenhouse for storing solar energy is a significant development for molecular solar thermal systems. In addition, the conversion by fluorescent light bulb irradiation is also a unique and unexpected result. 67-83% of Z was obtained by the fluorescent light irradiation. The disclosed compounds exhibit extremely long half-lives of Z isomers (723 days, 258 days, 8.7 years, and 322 days for compound 1, 2, 3, 4, respectively).

### BRIEF DESCRIPTION OF THE DRAWINGS

FIGS. 1A-D show the operation principle of solar heat and photon energy storage by photo-switchable organic phase-change materials (PCM) (FIG. 1A); reversible structural isomerization of compound 1 by photo-irradiation (FIG. 1B); UV-Vis absorption spectra of as-synthesized compound 1 (1-E) as well as the compound at the respective photostationary state under 430 nm and 530 nm irradiation (FIG. 1C); and chemical structures of photo-switchable PCMs either developed in this application (compounds 1-5) or previously reported (FIG. 1D). The wavelength that maximizes E-to-Z isomerization of each compound is listed. E_{storage}: total energy storage, ΔHₘ: melting enthalpy, ΔHᵢₛₒ: isomerization enthalpy.

FIG. 2 shows UV-Vis absorption spectra of compounds 1-5.

FIGS. 3A-L show differential scanning calorimetry plots of E and Z isomers of compound 2 as a representative example of compounds 1,2 and 4 (FIG. 3A); a greenhouse setup (FIG. 3B); a schematic illustration of the simultaneous phase transition and E-Z isomerization induced by the solar heat and visible-light-range solar irradiation through a band-pass filter (FIG. 3C); UV-Vis transmission spectra of band-pass filter (BPF) 1-7 (FIGS. 3G-H); and optical images of a crystalline film of compound 1-E (FIGS. 3I-J) and a liquid film of compound 1-Z (FIG. 3K-L). FIG. 3B shows a greenhouse setup under direct solar irradiation which allows for the UV-Vis photon absorption by the compound at an elevated temperature. FIG. 3C is a schematic illustration of the simultaneous phase transition and E-Z isomerization induced by the solar heat and visible-light-range solar irradiation through a band-pass filter. The initial crystalline E sample was regenerated after the optically-triggered heat release from the liquid Z by the blue LED (430 nm) irradiation. FIG. 3I an optical image of a crystalline film of compound 1-E. FIG. 3J is a magnified microscope image of the boxed area in FIG. 3I. FIG. 3K is an optical image of a liquid film of compound 1-Z after the solar irradiation through BPF 4 in the greenhouse for 5 hours. FIG. 3L is a magnified microscope image of the boxed area in FIG. 3K.

FIG. 4 shows DSC plots illustrating thermal properties of E-isomer (top curve), Z-isomer (mid curve), and the thermal isomerization of Z-isomer (bottom curve) for compounds 1-5. The following thermal parameters are labeled in these plots: crystallization temperature (T_{c}), melting temperature (Tₘ), cold-crystallization temperature (T_{cc}), onset temperature of Z-to-E thermal reverse isomerization (Tᵢₛₒ), and glass transition temperature (T_{g}). The first heating (●), cooling (▪), and second heating (▴) curves are shown. To demonstrate the cold-crystallization of 1-Z, 3-Z, 3-E, DSC heating/cooling rate was set at 1° C./min, except for the first heating scan for 3-Z and 3-E run at 10° C./min.

FIGS. 5A-B are images showing surface temperature measurements of the greenhouse. In one measurement, shown in FIG. 5A, ambient temperature was 28° C. and the temperature measured on black and white areas was 40.2° C. and 35.5° C., respectively. In another measurement, shown in FIG. 5B, ambient temperature was 31° C., and the temperature measured on the black surface was 41° C. The film of 1-E melted in the greenhouse.

FIGS. 6A-G show ratio of Z isomer (%) in solid films of compound 1 exposed to 530 nm LED (FIG. 6A); maximum % Z of compounds 1-5 achieved by the solar irradiation or external light source illumination (FIG. 6B); and the process of direct solar energy storage by a crystalline powder sample (1-E) (FIGS. 6C-G). FIG. 6A is a graph showing an increasing ratio of Z isomer (%) in solid films of compound 1 exposed to 530 nm LED at 50° C. Each irradiated sample formed a liquid phase which was stable for various durations (i.e. latent heat storage time) before crystallizing. FIG. 6B is a graph showing the maximum % Z of compounds 1-5 achieved by the unfiltered and band-pass-filtered solar irradiation or external light source (LED and fluorescent light bulb) illumination. FIGS. 6C-G show the process of direct solar energy storage by a crystalline powder sample (1-E) in a magnetically-stirred container covered by BPF 5 and placed in a greenhouse. The entire sample turned liquid containing 72% Z isomer within 5 hours of exposure to sunlight at 31° C. ambient temperature. The liquid phase solidified within the 15 min exposure to blue LED light while being stirred for the uniform exposure.

FIG. 7 is a graph showing integration E_{e of} solar irradiance spectrum (ASTM G-173-031 reference spectra) (2020), Standard Tables for Reference Solar Spectral Irradiances: Direct Normal and Hemispherical on 37° Tilted Surface,” ASTM International, West Conshohocken, PA, which is hereby incorporated by reference in its entirety) at 360 nm, 430 nm, 530 nm, 590 nm, and 625 nm with 10 nm bandwidth.

FIG. 8 is a transmission spectrum of a 360 nm bandpass filter.

FIG. 9 is a transmission spectra of a greenhouse glass and a cover glass slide.

FIG. 10 is a graph showing percentage of 1-Z isomer measured upon 530 nm irradiation in thin films.

FIGS. 11A-F are images showing the impact of the irradiation time on the liquid phase stability (latent heat storage time). Five identical E-rich 1 films were irradiated at 530 nm for various durations then monitored in dark until crystallization was observed. FIG. 11A is an image taken immediately after the irradiation at 530 nm, where a stable liquid film is obtained. FIG. 11B an image of 1 min-irradiated film crystallized after 1 day. FIG. 11C is an image of 2 min-irradiated film crystallized after 3 days. FIG. 11D is an image of 3 min-irradiated film crystallized after 8 days. FIG. 11E is an image of 4 min-irradiated film crystallized after 26 days. FIG. 11F is an image of 5 min-irradiated film still remaining as liquid after a month.

FIG. 12 shows emission spectra of the 430 nm, 530 nm, 590 nm, and 625 nm LEDs (Thorlabs “Mounted LEDs,” accessed from www.thorlabs.com in December 2020), which is hereby incorporated by reference in its entirety).

FIGS. 13A-B are graphs showing rheometry measurements. FIG. 13A is a graph showing complex viscosity measured by strain sweep. FIG. 13B is a graph showing complex viscosity measured by frequency sweep.

FIGS. 14A-D are images showing optically-triggered heat release measured by IR thermal camera. FIG. 14A is IR camera image of 1-Z stirred in a quartz cuvette in the dark within initial 30 secs. FIGS. 14B-C are IR camera images captured at the highest temperatures measured from 1-Z in a quartz cuvette under 430 nm irradiation. FIG. 14D is IR camera image of 1-E in a quartz cuvette under 430 nm irradiation.

FIGS. 15A-E show the results of irradiation of compound 1. FIG. 15A is a graph showing a decreasing ratio of Z isomers (%) in the liquid films of compound 1 exposed to 430 nm LED at room temperature. Upon 20 and 40 sec irradiation, each liquid film crystallized after various delays, whereas 80 and 160 sec irradiated films crystallized immediately. FIG. 15B shows images of 20 sec irradiated film containing more than 50%E, which showed a relatively slower nucleation and gradual crystal propagation that was captured by optical microscopy of the identical sample area. FIG. 15C is a graph depicting energy conversion efficiency (ECE, %) calculated for the latent heat storage and release, showing the larger heat output than input as well as substantially larger photon energy input required for photo-switching. FIG. 15D shows a schematic illustration of the selective photo-induced crystallization process of liquid sample. FIG. 15E shows optical microscope images of a liquid film before and after selective crystallization via 430 nm irradiation, showing a clear distinction between the irradiated and covered area of sample. The dotted boxes mark the areas that are further magnified under the microscope and shown on the right.

FIG. 16 is a graph showing percentage of 1-E isomer measured upon 430 nm irradiation on 1-Z in thin films.

FIGS. 17A-E show structural isomerization of compound 3 by an unfiltered fluorescent light irradiation (E-to-Z) and blue LED illumination (Z-to-E). FIG. 17A shows reversible structural isomerization of compound 3 by an unfiltered fluorescent light irradiation (E-to-Z) and blue LED illumination (Z-to-E). FIG. 17B shows UV-Vis absorption spectra of as-synthesized compound 3 (OFF) as well as the compound switched to Z isomeric form (ON). FIG. 17C shows the normalized emission of a fluorescent light bulb and a blue LED used in the experiments. FIG. 17D is a schematic illustration of the selective photo-switching of the supercooled liquid 3-E. FIG. 17E shows optical microscope images of the liquid film before and after selective fluorescent light irradiation for 90 min, showing a clear distinction between the irradiated 3-Z (liquid) and covered 3-E (crystallized) areas of sample. The dotted boxes mark the areas that are further magnified under microscope and shown on the right.

FIGS. 18A-C are graphs showing the Eyring-Polanyi plot of thermal Z-to-E isomerization of compounds 2-4. Acetonitrile was used as solvent in FIG. 18A and 18C. DMSO was used as solvent in FIG. 18B.

### DETAILED DESCRIPTION OF THE INVENTION

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “alkyl”, “hydrocarbon”, “saturated hydrocarbon” means an aliphatic hydrocarbon group which may be straight or branched having a recited number of carbon atoms in the chain. Branched means that one or more lower alkyl groups such as methyl, ethyl or propyl are attached to a linear alkyl chain. Exemplary alkyl groups include methyl, ethyl, n-propyl, i-propyl, n-butyl, t-butyl, n-pentyl, and 3-pentyl.

The term “unsaturated hydrocarbon” means alkenyl or alkynyl.

The term “alkenyl” means an aliphatic hydrocarbon group containing a carbon-carbon double bond and which may be straight or branched having a recited number of carbon atoms (at least two) in the chain. Branched means that one or more lower alkyl groups such as methyl, ethyl, or propyl are attached to a linear alkenyl chain. Exemplary alkenyl groups include ethenyl, propenyl, n-butenyl, and i-butenyl.

The term “alkynyl” means an aliphatic hydrocarbon group containing a carbon-carbon triple bond and which may be straight or branched having a recited number of carbon atoms (at least two) in the chain. Branched means that one or more lower alkyl groups such as methyl, ethyl, or propyl are attached to a linear alkynyl chain. Exemplary alkynyl groups include ethynyl, propynyl, n-butynyl, 2-butynyl, 3-methylbutynyl, and n-pentynyl.

The term “alkoxy” means groups of from 1 to 6 carbon atoms of a straight, branched, or cyclic configuration and combinations thereof attached to the parent structure through an oxygen. Examples include methoxy, ethoxy, propoxy, isopropoxy, butoxy, cyclopropyloxy, cyclohexyloxy, and the like. Alkoxy also includes methylenedioxy and ethylenedioxy in which each oxygen atom is bonded to the atom, chain, or ring from which the methylenedioxy or ethylenedioxy group is pendant so as to form a ring. Thus, for example, phenyl substituted by alkoxy may be, for example,

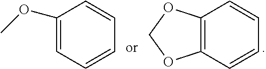

The term “aryl” means an aromatic monocyclic or multicyclic ring system of 6 to about 14 carbon atoms, preferably of 6 to about 10 carbon atoms. Representative aryl groups include phenyl and naphthyl.

The term “heteroaryl” means an aromatic monocyclic ring system of 5 or 6 ring atoms, in which one or more of the atoms in the ring system is/are element(s) other than carbon, for example, nitrogen, oxygen, or sulfur. The prefix aza, oxa, thia, or thio before heteroaryl means that at least a nitrogen, oxygen, or sulfur atom, respectively, is present as a ring atom. A nitrogen atom of a heteroaryl is optionally oxidized to the corresponding N-oxide. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b ]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6,7-dihydro-4H-pyrazolo[5,1-c][1,4]oxazinyl, 2-oxo-2,3-dihydrobenzo [d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like.

Preferred heteroaryls include imidazolyl, oxazolyl, isoxazolyl, thiazolyl, and isothiazolyl rings.

The term “halogen” means fluoro, chloro, bromo, or iodo.

The term “substituted” or “substitution” of an atom means that one or more hydrogen on the designated atom is replaced with a selection from the indicated group, provided that the designated atom's normal valency is not exceeded.

“Unsubstituted” atoms bear all of the hydrogen atoms dictated by their valency. When a substituent is keto (i.e., ═O), then two hydrogens on the atom are replaced.

Combinations of substituents and/or variables are permissible only if such combinations result in stable compounds; by “stable compound” or “stable structure” is meant a compound that is sufficiently robust to survive isolation to a useful degree of purity from a reaction mixture.

A first aspect of the present application relates to a compound of Formula (I):

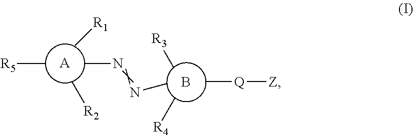

wherein
[symbol] and [symbol] are independently aryl or heteroaryl 5- or 6-membered rings;
R¹, R², R³, and R⁴ are each in an ortho position to the azo group, and each is independently selected from halogen, C₁ to C₆ alkoxy, C₁ to C₆ alkylthio, halomethyl, dihalomethyl, trihalomethyl, and di(C₁ to C₆ alkyl)amino;
R⁵ is H, C₁ to C₆ alkyl, C₁ to C₆ alkoxy, halogen, trihalomethyl, or cyano;
Q is X is —OC(O)—, —OC(S)—, —NHC(O)—, —SC(O)—, —NRC(S)—, —NRC(O)NR—, —NHC(S)NH—, —C(O)NHC(O)—; and
Z is a C₆ to C₁₈ straight- or branched-chain hydrocarbon.

According to one embodiment of this first aspect, the compound has the structure of Formula (Ia):

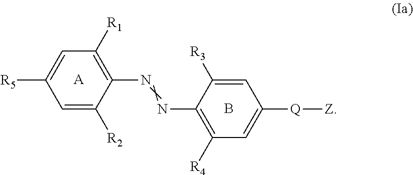

Groups [symbol] and [symbol] in the compound of Formula (I) can be the same or different . In some embodiments, [symbol] and [symbol] are independently selected from the group consisting of phenyl, imidazolyl, oxazolyl, isoxazolyl, thiazolyl, and isothiazolyl.

Groups R¹, R², R³, and R⁴ in the compound of Formula (I) or (Ia) can be the same or different. According to one embodiment of this first aspect, each of R¹, R², R³, and R⁴ groups in the compound of Formula (I) or (Ia) is a halogen independently selected from F, Cl, and Br. According to another embodiment of this first aspect, each of R¹, R², R³, and R⁴ groups in the compound of Formula (I) or (Ia) is independently selected from F or Cl. According to yet another embodiment of this first aspect, each of R¹, R², R³, and R⁴ groups in the compound of Formula (I) or (Ia) is independently selected from methoxy or ethoxy. According to a further embodiment of this first aspect, two of R¹, R², R³, and R⁴ groups in the compound of Formula (I) or (Ia) are F, and the other two of R¹, R², R³, and R⁴ are Cl.

According to one embodiment of this first aspect, the Z group in the compound of Formula (I) or (Ia) is a C₁ to C₃₀ straight-chain hydrocarbon. In certain embodiments, these hydrocarbons may include, for example, C₁ to C₇ straight-chain hydrocarbon, C₈ to C₂₀ straight-chain hydrocarbons, or C₂₁ to C₃₀ straight-chain hydrocarbons. According to another embodiment of this first aspect, the Z group in the compound of Formula (I) or (Ia) is a C₁ to C₃₀ branched-chain hydrocarbon. In certain embodiments, these hydrocarbons may include, for example, C₁ to C₁₃ branched-chain hydrocarbon, or C₁₄ to C₃₀ branched-chain hydrocarbons These straight- and branched-chain hydrocarbons can be either saturated or mono-or poly-unsaturated.

Exemplary Z groups include, without limitation, the following hydrocarbons: —CH₃, —(CH₂)CH₃, —(CH₂)₂CH₃, —(CH₂)₃CH₃, —(CH₂)₄CH₃, —(CH₂)₅CH₃, —(CH₂)₆CH₃, —(CH₂)₇CH₃, —(CH₂)₈CH₃, —(CH₂)₉CH₃, —(CH₂)₁₀CH₃, —(CH₂)₁₁CH₃, —(CH₂)₁₂CH₃, —(CH₂)₁₃CH₃, —(CH₂)₁₄CH₃, —(CH₂)₁₅CH₃, —(CH₂)₁₇CH₃, —(CH₂)₁₉CH₃, —(CH₂)₂₁CH₃, —(CH₂)₂₃ CH₃, —(CH₂)₂₅CH₃, —(CH₂)₂₇CH₃, —(CH₂)₂₉CH₃, —CH[CH₂CH₃][(CH₂)₄CH₃)], —CH[CH₂CH₃][(CH₂)₅CH₃)], —CH[CH₂CH₃][(CH₂)₆CH₃)], —CH[CH₂CH₃][(CH₂)₇CH₃)], —CH[CH₂CH₃][(CH₂)₈CH₃)], —CH[CH₂CH₃][(CH₂)₉CH₃)], —CH[CH₂CH₃][(CH₂)₁₀CH₃)], —CH[CH₂CH₃][(CH₂)₁₁CH₃)], —CH[(CH₂)₂CH₃)][(CH₂)₄CH₃)], —CH[(CH₂)₂CH₃)][(CH₂)₅CH₃)], —CH[(CH₂)₂CH₃)][(CH₂)₆CH₃)], —CH[(CH₂)₂CH₃)][(CH₂)₇CH₃)], —CH[(CH₂)₂CH₃)][(CH₂)₈CH₃)], —CH[(CH₂)₂CH₃)][(CH₂)₉CH₃)], —CH[(CH₂)₂CH₃)][(CH₂)₁₀CH₃)], —CH[(CH₂)₂CH₃)][(CH₂)₁₁CH₃)], —CH═CH₂, —CH═CH—CH₃, —CH₂—CH═CH₂, —CH═CH—CH₂—CH₃, —(CH₂)₂—CH═CH₂, —CH═CH—(CH₂)₂CH₃, —(CH₂)₃—CH═CH₂, —CH═CH—(CH₂)₃CH₃, —(CH₂)₄—CH═CH₂, —CH═CH—(CH₂)₄CH₃, —(CH₂)₅—CH═CH₂, —CH═CH—(CH₂)₅CH₃, —(CH₂)₆—CH═CH₂, —CH═CH—(CH₂)₆CH₃, —(CH₂)₇—CH═CH₂, —CH═CH—(CH₂)₇CH₃, —(CH₂)₈—CH═CH₂, —CH═CH—(CH₂)₈CH₃, —(CH₂)₉—CH═CH₂, —CH═CH—(CH₂)₉CH₃, —(CH₂)₁₀—CH═CH₂, —CH═CH—(CH₂)₁₀CH₃, —(CH₂)₁₁—CH═CH₂, —CH═CH—(CH₂)₁₁CH₃, —(CH₂)₁₂—CH═CH₂, —CH═CH—(CH₂)₁₂CH₃, —(CH₂)₁₃—CH═CH₂, —CH═CH—(CH₂)₁₃CH₃, —(CH₂)₁₄—CH═CH₂, —CH═CH—(CH₂)₁₄CH₃, —(CH₂)₁₅—CH═CH₂, —CH═CH—(CH₂)₁₅CH₃, —(CH₂)₁₇—CH═CH₂, —CH═CH—(CH₂)₁₇CH₃, —(CH₂)₁₉—CH═CH₂, —CH═CH—(CH₂)₁₉CH₃, —(CH₂)₂₁—CH═CH₂, —CH═CH—(CH₂)₂₁CH₃, —(CH₂)₂₃—CH═CH₂, —CH═CH—(CH₂)₂₃CH₃, —(CH₂)₂₅—CH═CH₂, —CH—CH—(CH₂)₂₅CH₃, —(CH₂)₂₇—CH═CH₂, —CH═CH—(CH₂)₂₇CH₃, —CH═CH—CH[CH₂CH₃][(CH₂)₄(CH₃)], —CH═CH—CH[CH₂CH₃][(CH₂)₅CH₃)], —CH═CH—CH[CH₂CH₃][(CH₂)₆CH₃)], —CH═CH—CH[CH₂CH₃][(CH₂)₇CH₃)], —CH═CH—CH[CH₂CH₃][(CH₂)₈CH₃)], —CH═CH—CH[CH₂CH₃][(CH₂)₉CH₃)], —CH═CH—CH[CH₂CH₃][(CH₂)₁₀CH₃)], —CH═CH—CH[CH₂CH₃][(CH₂)₁₁CH₃)], —CH═CH—CH[(CH₂)₂CH₃)][(CH₂)₄CH₃)], —CH═CH—CH[(CH₂)₂CH₃)][(CH₂)₅CH₃)], —CH═CH—CH[(CH₂)₂CH₃)][(CH₂)₆CH₃)], —CH═CH—CH[(CH₂)₂CH₃)][(CH₂)₇CH₃)], —CH═CH—CH[(CH₂)₂CH₃)][(CH₂)₈CH₃)], —CH═CH—CH[(CH₂)₂CH₃)][(CH₂)₉CH₃)], —CH═CH—CH[(CH₂)₂CH₃)][(CH₂)₁₀CH₃)], and —CH═CH—CH[(CH₂)₂CH₃)][(CH₂)₁₁CH₃)].

According to one embodiment of this first aspect, the Q group in the compound of Formula (I) or (Ia) is —OC(O)— or —OC(S)—.

Exemplary compounds of Formula (I) or (Ia) include, without limitation:

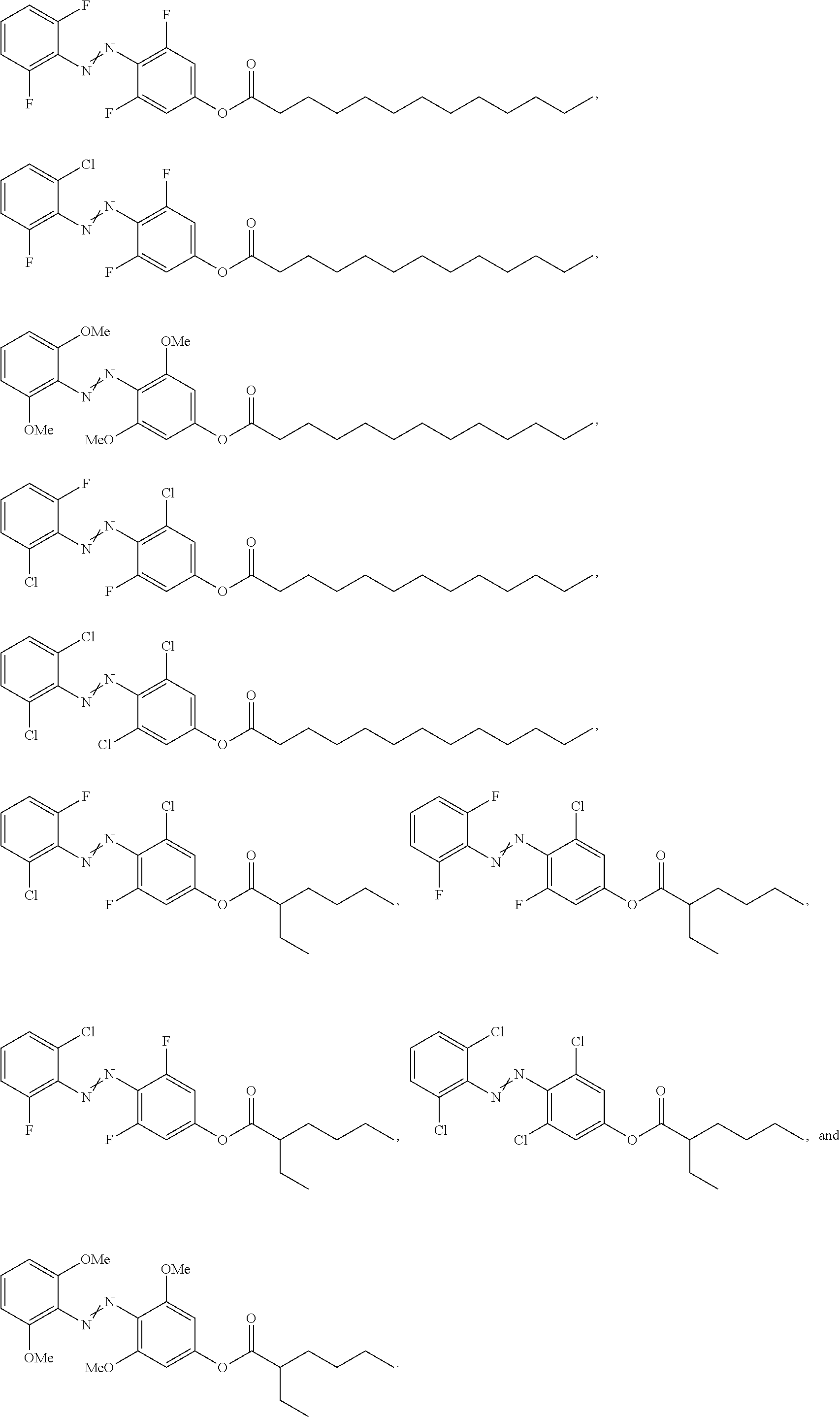

According to another embodiment of this first aspect, the compound of Formula (I) or (Ia) is present in a form of a Z-isomer. According to another embodiment of this first aspect, the compound of Formula (I) or (Ia) is present in a form of a E-isomer. According to yet another embodiment of this first aspect, the compound of Formula (I) or (Ia) is present in the form of a mixture of a Z-isomer and an E-isomer.

Another aspect of the present application relates to a process for preparation of a compound of Formula (I) or (Ia). These compounds of Formula (I) and (Ia) can be prepared according to several processes, which are described and illustrated in the accompanying examples. Additional synthesis procedures, outlined below, can be adapted from previously reports (as cited below), each of which is hereby incorporated by reference in its entirety.

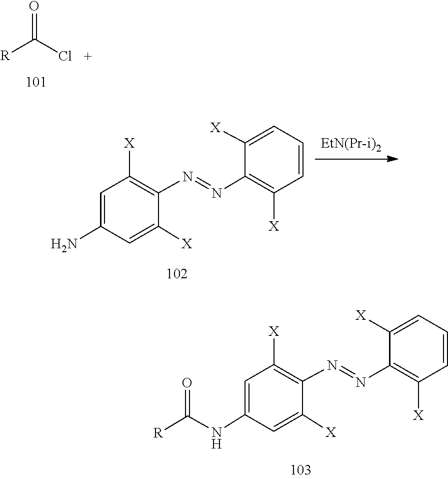

Compounds of Formula (I) or (Ia) of the present application can be prepared by reacting acyl chloride (101) with azobenzene (102) in a presence of a base, such as diisopropyl ethyl amine (Banghart et al., “Photochromic Blockers of Voltage-Gated Potassium Channels,” Angewandte Chemie 48(48):9097-9101 (2009), which is hereby incorporated by reference in its entirety).

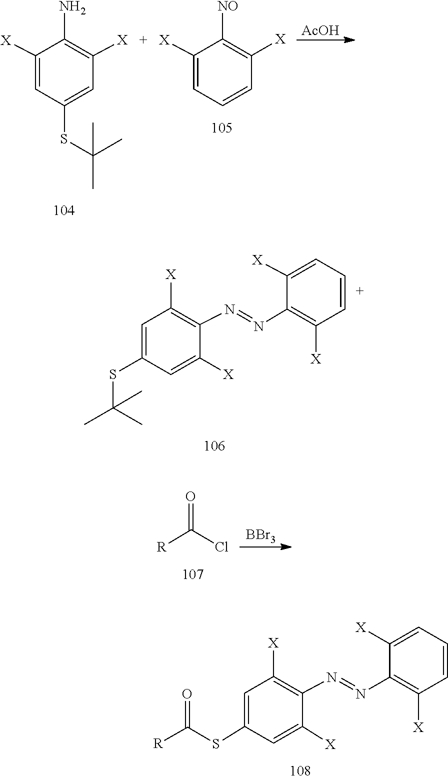

Compounds of Formula (I) or (Ia) of the present application can also be prepared by first reacting amine (104) with nitrobenzene (105) to form azobenzene (106). Subsequently, azobenzene (106) can be acylated using acylchloride (107) (Crivillers et al., “Large Work Function Shift of Gold Induced by a Novel Perfluorinated Azobenzene-Based Self-Assembled Monolayer,” Adv. Materials 25(3):432-436 (2013), which is hereby incorporated by reference in its entirety).

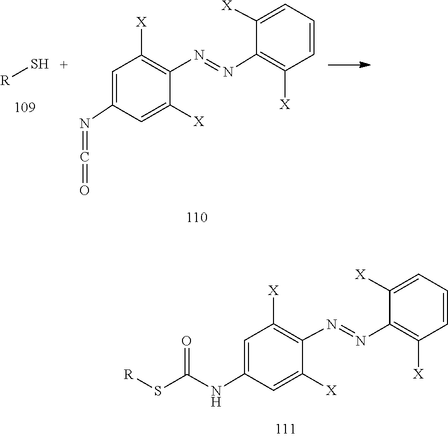

Compounds of Formula (I) or (Ia) of the present application can be prepared by reacting thiol (109) with azobenzene (110) in aqueous alkali (Dalton et al., “Syntheses of Some Thiol Esters for Acylation of Proteins,” Australian J Chemistry 34:759-764 (1981), which is hereby incorporated by reference in its entirety).

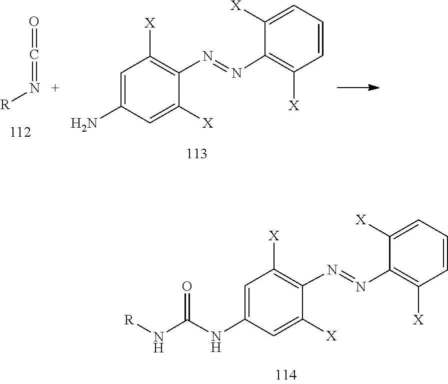

Compounds of Formula (I) or (Ia) of the present application can also be prepared by reacting isocyanate (112) with azobenzene (113) under reflux in anhydrous acetonitrile (Dabrowa et al., “Anion-Tunable Control of Thermal Z—E Isomerisation in Basic Azobenzene Receptors,” Chem. Commun. 50:15748-15751 (2014), which is hereby incorporated by reference in its entirety).

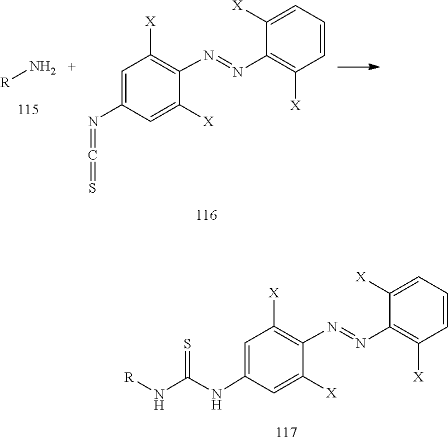

Compounds of Formula (I) or (Ia) of the present application can be prepared by reacting acyl amine (115) with azobenzene (116) in a mixture of ethanol with 1,2-dichloroethane (Kato et al., “Optical Detection of Anions Using N-(4-(4-Nitrophenylazo)phenyl)-N′-propyl Thiourea Bound Silica Film,” New J. Chem. 37:717-721 (2013), which is hereby incorporated by reference in its entirety).

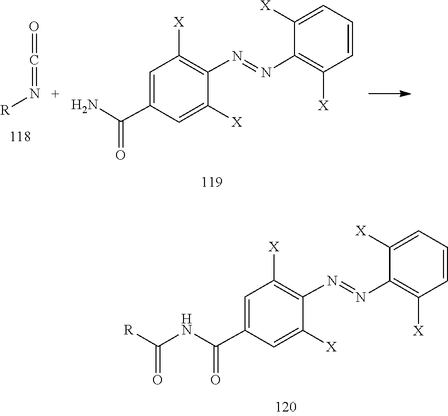

Compounds of Formula (I) or (Ia) of the present application can be prepared by reacting isocyanate (118) with azobenzene (119) in a toluene (Tian et al., “Azobenzene-Benzoylphenylureas as Photoswitchable Chitin Synthesis Inhibitors,” Org. Biomol. Chem. 15:3320-3323 (2017), which is hereby incorporated by reference in its entirety).

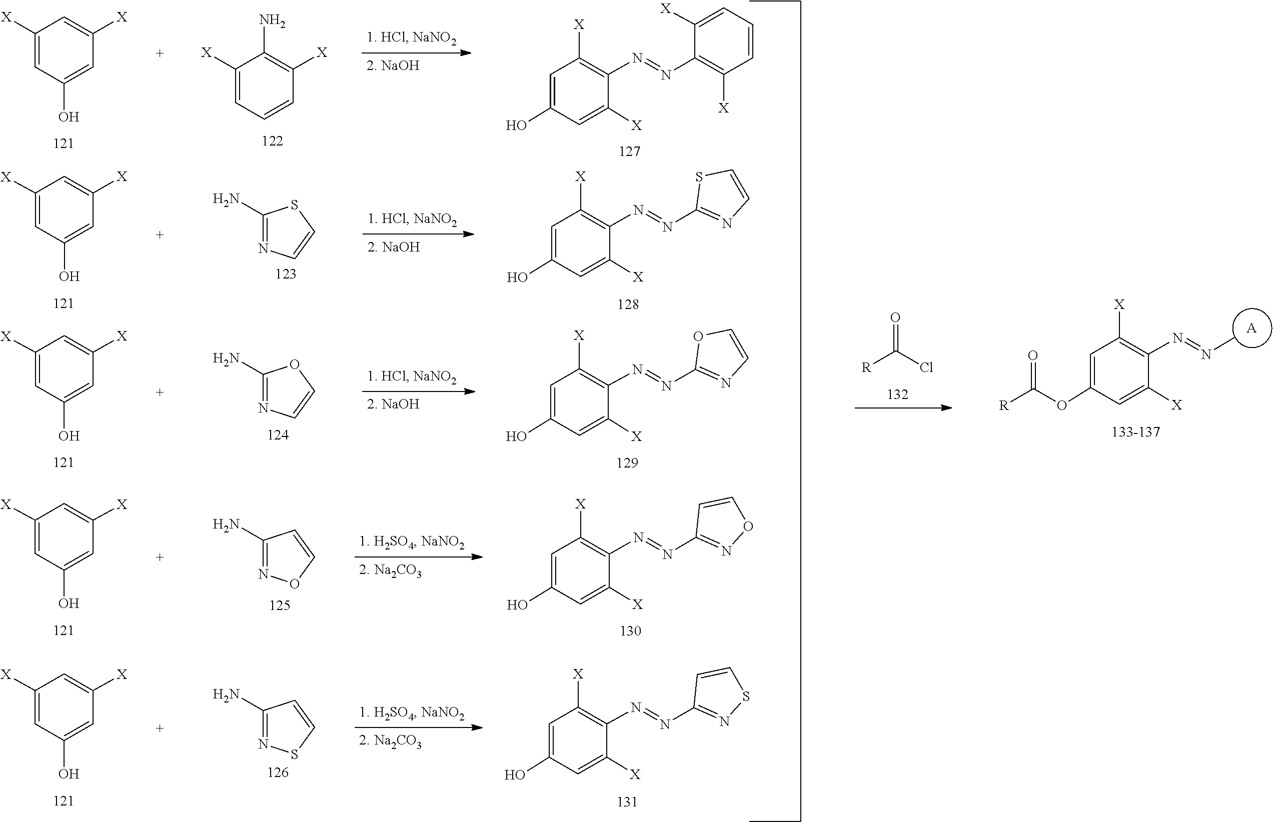

Compounds of Formula (I) or (Ia) of the present application can be prepared by reacting compound (121) with aryl amine or heteroaryl amine (122-126) to form azobenzenes (127-131). Subsequently, azobenzenes (127-131) can be acylated using acylchloride (132) (Li et al., “Smart Azobenzene-Containing Tubular Polymersomes: Fabrication and Multiple Morphological Tuning,” Chem. Commun., 56:6237-6240 (2020); Huang et al., “Synthesis and Z-Scan Measurements of Third-Order Optical Nonlinearity of Azothiazole- and Azobenzothiazole-Containing Side-Chain Polymers, ” Polym. Bull. 73:1545-1552 (2016); Sener et al., “Azocalixarenes. 3: Synthesis and investigation of the Absorption Spectra of Hetarylazo Disperse Dyes Derived From Calix[4]arene,” Dyes and Pigments 62(2):141-148 (2004), which are hereby incorporated by reference in their entirety).

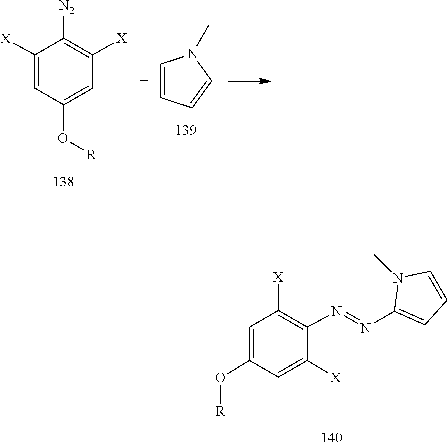

Compounds of Formula (I) or (Ia) of the present application can also be prepared by reacting compound (138) with pyrrole derivative (139) in the presence of dicyclohexyl-18-crown-6 (Anderson et al., “Benzenediazonium Ions: Structure, Complexation, and Reactivity,” J. Chem. Soc., 2:1239-1241 (1987), which is hereby incorporated by reference in its entirety).

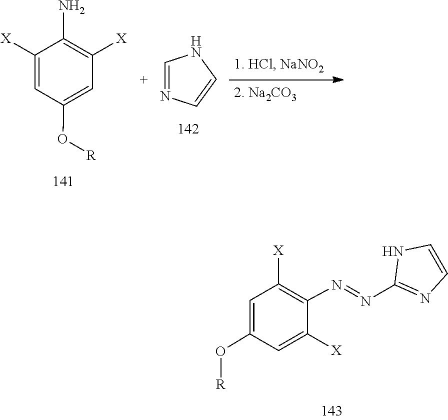

Compounds of Formula (I) or (Ia) of the present application can be prepared by first diazotizing aniline derivative (141) with sodium nitrite in hydrochloric acid and then reacting the intermediate with imidazole (142) and anhydrous sodium carbonate (Lin et al., “Properties and Applications of Designable and Photo/Redox Dual Responsive Surfactants With the New Head Group 2-Arylazo-imidazolium,” RSC Adv. 6:51552-51561 (2016), which is hereby incorporated by reference in its entirety).

According to one embodiment, where Q is —OC(O)— or —OC(S)—, the process includes the steps of providing a compound of Formula (II) or (IIa):

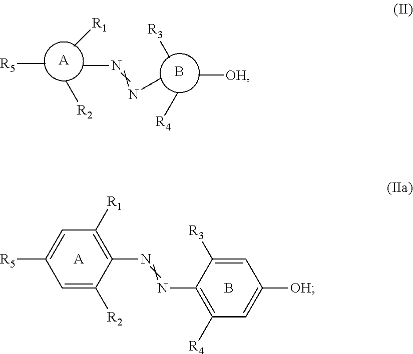

and reacting the compound of formula (II) or (IIa) with

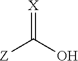

under conditions effective to form the compound according to formula (I) or (Ia). In one embodiment X is O, and in another embodiment X is S.

In one embodiment, the reaction conditions comprise effective amounts of N,N′-dicyclohexylcarbodiimide and 4-dimethylaminopyridine dissolved in dichloromethane.

In another embodiment, the compound of formula (II) or (IIa) is prepared by reacting, under effective conditions, a compound according to (III) or (IIIa)

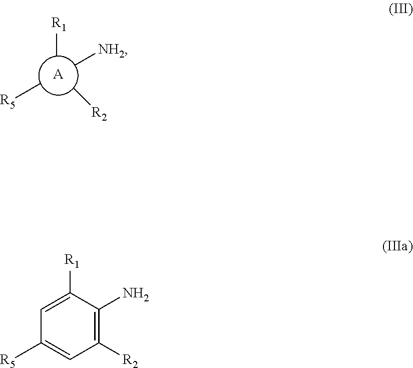

with a compound according to (IV) or (IVa),

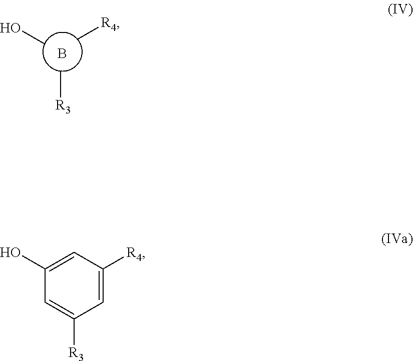

respectively, where R₁ to R₅ are defined as set forth above.

Another aspect of the present application relates to a composition that includes one or more compounds of Formula (I) or Formula (Ia) according to the first aspect of the application.

In one embodiment, the composition consists of a single compound of Formula (I) or (Ia) in a substantially pure form, such as at least about 95% pure, at least about 97% pure, at least about 98% pure, or at least about 99% pure. This is without regard to the (E)/(Z) form of the compound.

In another embodiment, the composition contains two or more compounds of Formula (I) or (Ia), with or without additional diluents. This is without regard to the (E)/(Z) form of the compound.

In a further embodiment, the composition further contains one or more compounds of Formula (I), (Ia), with or without additional diluents.

Suitable diluents include, without limitation, organic solvents as well as organic phase-change materials (PCM) in which the compounds are dispersed while in the liquid state.

Phase-change materials (PCM) for use in the present application include alkanes (aliphatic hydrocarbons), fatty acids, fatty alcohols, fatty acid esters, paraffin waxes, polyethylene glycols, sugar alcohols, salts of fatty acid, and combinations thereof. They can have an origin derived from animal fat, animal grease, vegetable oil, vegetable wax, synthetic compounds and/or combinations of two or more thereof. Due to phenomena described by freezing point depression theory, mixtures generally tend to release latent heat over a larger temperature range than pure components. Whereas pure components are often referred to as having a melting point temperature, mixtures typically have a melting point temperature range.

In some embodiments, the composition further comprises an organic phase-change material in which the compounds of Formula (I) or (Ia) are dispersed while in the liquid state.

In certain embodiments, the organic phase-change material comprises one or more of aliphatic hydrocarbons, fatty acids, fatty alcohols, or combinations thereof.

The aliphatic hydrocarbons, fatty acid, and fatty alcohol phase change materials can have a C8 to C30 hydrocarbon chain, preferably those having a C10 to C30 hydrocarbon chain. The hydrocarbon chain can be saturated or unsaturated, although it is preferably saturated. In one embodiment, the composition includes a fatty acid or fatty alcohol as the phase change material.

Suitable fatty acids include those occurring naturally in triglycerides as well as synthetic fatty acids. Fatty acids can be obtained from the hydrolysis of triglycerides, as is well known in the art. Exemplary fatty acids for use in the preset application include, but are not limited to oleic acid, palmitic acid, linoleic acid, palmitoleic acid, stearic acid, tridecanoic acid, pentadecanoic acid, heptadecanoic acid, nonadecanoic acid, caprylic acid, capric acid, and lauric acid as well as combinations of two or more thereof. Frequently available fatty acids can be hydrates and hydrogenated acids of any of the preceding acids.

The fatty acid esters can be formed with alcohols, diols, and/or polyols, including, but not limited to, mono-, di- or triglycerides of glycerol, esters of pentaerythritol, polyesters of polyhydric alcohols, esters of methanol, ethanol, propanol, butanol, isobutanol, pentanol, hexanol, cyclohexanol, esters or diesters of ethylene glycol and/or combinations of two or more thereof. The fatty acid esters can be mono-, di- or triglycerides of glycerol, and/or combinations thereof. Additionally, the fatty acid esters can be ester of higher fatty acids with higher monohydric alcohols.

Esters of fatty acids can be formed by a variety of methods known in the art including transesterification or hydrolysis followed by esterification. The advantage of this approach is that relatively pure components having targeted melting point temperatures can be synthesized.

For example, a multitude of esters of oleic acid can be formed by complete esterification with methanol, ethanol, propanol, butanol, isobutanol, pentanol, hexanol, cyclohexanol, phenol, ethylene glycol, glycerin, diethylene glycol, and many more. To a first approximation, the oleate esters formed with each of these esters will result in different melting point temperatures. Furthermore, mixtures of two of the esters have the potential to form mixtures having relatively narrow and useful melting point temperature ranges.

Exemplary fatty alcohols for use as PCMs include, but are not limited to, dodecanol (lauryl alcohol), tetradecanol (myristyl alcohol), hexadecanol (cetyl alcohol), and octadecanol (stearyl alcohol).

In another embodiment, the phase change material is a long chain alkanes or alkene with minimal branching, or no branching; of these, long chain alkanes with minimal branching are preferred. These hydrocarbons are able to solidify at temperatures above 0° C., and can absorb heat and melt. Alkanes ranging in carbon length from C14 to C30 may be particularly useful in the present application. Exemplary alkane PCMs of the present application include, but are not limited to long chain aliphatic such as tetradecane, pentadecane, hexadecane, heptadecane, octadecane, nonadecane, icosane, henicosane, docosane, tricosane, tetracosane, pentacosane, hexacosane, heptacosane, octacosane, nonacosane, icosane, and triacontane.

Additionally, natural and synthetic polymers may be use for phase change materials in the present application. Exemplary polymers include, but are not limited to polyethylene glycol, polypropylene glycol, polytetramethylene glycol, poly(N-isopropyl acrylamide), poly(diethyl acrylamide), poly(tert-butylacrylate), poly(isopropyl methacrylamide), hydroxypropyl cellulose, hydroxymethyl cellulose, poly(oxazoline), and poly(organophosphazenes).

A sugar alcohol (also known as a polyol, polyhydric alcohol, or polyalcohol) is a hydrogenated form of a saccharide, whose carbonyl group (aldehyde or ketone, reducing sugar) has been reduced to a primary or secondary hydroxyl group. They are commonly used for replacing sucrose in foodstuffs, often in combination with high intensity artificial sweeteners to counter the low sweetness. Exemplary sugar alcohols that may be used in the present application as PCMs include, but are not limited to, xylitol, pentaerythrite, trimethylolethane, erythrite, mannitol, neopentyl glycol and mixtures thereof.

Further examples of phase change materials that can may be used in the present application are disclosed in U.S. Pat. No. 6,574,971 to Suppes; and U.S. Pat. No. 8,308,861 to Rolland et al.; U.S. Pat. No. 7,645,803 to Tamarkin et al.; and U.S. Patent Application Publication No. 2019/0092992 to Raj agopalan et al., all of which are hereby incorporated by reference in their entirety.

The optional organic phase-change material can be present, if desired, in an amount of about 10 to about 90 weight percent (based on the total weight of the composition). For example, the organic phase-change material can be present in the composition in an amount of about 15 to about 80 weight percent, about 20 to about 80 mol percent, about 25 to about 80 mol percent, about 30 to about 70 weight percent, about 35 to about 65 mol percent, about 40 to about 60 weight percent, or about 45 to about 55 mol percent. Alternatively, the organic phase-change material can be present in the composition in an amount of about 15 to about 85 weight percent, about 15 to about 70 weight percent, about 15 to about 65 mol percent, about 15 to about 60 weight percent, about 15 to about 55 mol percent, about 15 to about 50 weight percent, about 15 to about 45 mol percent, about 15 to about 40 weight percent, or about 15 to about 35 mol percent.

In certain embodiments, the composition further comprises a polymer solution or film in which the compounds of Formula (I), (Ia) are dispersed.

In one embodiment, the polymer solution or film is a polyolefin, a polyacrylate, a polystyrene, a polymethyl methacrylate, a polyester, a polyamide, a polyurethane, a polypropylene, a polyethylene (including polytetrafluoroethylenes and polychlorotrifluoroethylenes), or a combination of two or more such polymers, i.e., a (co)polymer film. Such films can be used as functional coatings or functional fabrics. Polymer based molecular solar thermal system (MOST) can be realized by compounding into existing polymer matrices of the types described above. Further substituents, like carbazole or benzophenones may be attached to the polymer to facilitate the photoisomerization process.

The compounds and compositions as described herein can be used to form various composite structures and thermal storage devices. The composite structures may form subcomponents of thermal storage devices.

In one aspect, the invention relates to a composite structure that includes a porous structural component and either a compound or a composition as described herein.

Exemplary porous structural components include, without limitation, an aerogel, a xerogel, a nanotube, metal organic framework, covalent organic framework, zeolite, graphene, graphene oxide, graphite, transition metal dichalcogenide, or hexagonal boron nitride.

In one aspect, the composite structure includes an enclosure that comprises an optically transparent wall and defines a compartment comprising a compound or a composition as disclosed herein.

In another embodiment, the optically transparent wall comprises a glass or polymeric material.

In another embodiment, the thermal storage system can comprise a light source that emits a wavelength of light suitable to induce an isomeric phase-change of the compound or composition of the composite structure, a switch that controls operation of the light source, and either a power source or a connector adapted for connecting the thermal storage system to a power source.

Thermal storage devices/systems that include a compound or composition as described herein can take any of a variety of configurations.

According to certain embodiments, the switch is a thermo-sensitive switch or a manually operable switch.

In accordance with another embodiment, a thermal conducting element forms a portion of the enclosure or the porous structural component.

In one embodiment, the power source is a battery.

In accordance with another embodiment, the thermal storage system can include a

reservoir for storing the liquid form of the compound (predominantly comprising the Z-isomer) and a pump.

In accordance with yet another embodiment, a thermal-storage device may include a compound or composition as described herein, where the compound or composition is retained on a substrate. The substrate may optionally include a thermal conducting element to facilitate heat transfer from the compound or composition to another article or the ambient environment during exothermic phase change, as discussed herein.

The thermal-storage device may optionally include a light source, as well as accompanying circuitry controls, to allow the light source to illuminate the disclosed compound or compositions, and thereby induce an isomeric phase-change for the compounds.

In accordance with one embodiment, a thermal-storage device may include a plurality of composition structures and a plurality of light sources.

In one embodiment, the light source(s) are LED light source(s).

One example of a thermal storage device is a device that is configured to facilitate heat transfer to engine oil or to stored water in accordance with the embodiments described and/or illustrated in PCT Application Publ. No. WO 2020/227227, which is hereby incorporated by reference in its entirety.

Another example of a thermal-storage device is a solar energy collector, which may optionally include a wavelength converter or an energy converter. Non-limiting examples of energy storage devices, including solar energy storage devices, are described in International Application Publication Nos. WO 2019/106029 A1 and WO 2016/097199 A1; U.S. Application Publication No. 20180355234 A1; Moth-Poulsen et al., “Molecular Solar Thermal (MOST) Energy Storage and Release System,” Energy Environ. Sci. 5:8534-8537 (2012); and Kashyap et al., “Full Spectrum Solar Thermal Energy Harvesting and Storage by a Molecular and Phase-Change Hybrid Material,” Joule 3(12): 3100-3111 (2019), each of which is hereby incorporated by reference in its entirety.

In these systems, it may be desirable to move the composition within the system from locations where the E-isoform can be exposed to solar energy and converted to the Z-isoform, and then moved to a separate location where the Z isoform can be stored and, later, converted to the E-isoform when harvesting the stored energy. Movement of the compounds or compositions can be carried out using pumping equipment. As long as there are some Z isomers in liquid form which can solvate the E isomer microcrystals, the whole sludge can be pumped. For example, the primarily crystalline form will be about 70-90% E-isoform and 10-30% Z isoform, whereas the primarily liquid form will be about 70-90% Z-isoform and 10-30% E-isoform.

Based on the foregoing, the compounds and compositions as described herein can be used in a method of storing energy. This method can be implemented using an energy storage device as described herein. The method include the following steps:
i) providing an energy storage device comprising one or more compounds according to Formula (I), or a composition comprising one or more compounds of Formula (I) whereby the one or compounds of Formula (I) is present as an E-isomer;
ii) activating the compounds of Formula (I) to produce a Z-isomer of the one or more compounds according to Formula (I); and
iii) storing the Z-isomer of the one or more compounds of Formula (I) for a period of time.

By including one or more compounds of Formula (I), there is a possibility to use a wider range of wavelengths when irradiating the system. Activating can involve heat and/or photon absorption, such as by using sunlight or fluorescent light. Depending on the compound(s) included in the system, the optimal wavelength of the irradiation can be determined and then utilized. Regardless of the manner of activation, the step involves solid-to-liquid phase change of the compound or composition of the invention.

In step iii), the period of storage may be cyclical, such as on a daily cycle where the storage period may be several hours (e.g., up to 12 or 18 hours), but it may be desirable to extend the period of storage such that it is acyclical (e.g., for as long as a user desires). As indicated in the examples, several of the compounds can store energy for long periods of time over several days, several weeks, and over several months. According to the present application, storing can be carried out for a period of time exceeding 12 hours. For example, storing is carried out for a period of time exceeding 24 hours, 36 hours, 48 hours, or 72 hours. Alternatively, storing can be carried out for a period of time from about 1 day up to about 21 days, about 2 days up to about 18 days, about 2 days up to about 14 days, about 3 days up to about 14 days, about 3 days up to about 10 days, or about 3 days up to about 7 days. Having stored the energy for later use, the method also includes the step of:
iv) inducing the Z-isomer of the one or more compounds of Formula (I) to isomerize back to E-isomer state, thereby releasing energy stored during said activating.

The energy released when one or more compounds of Formula (I) isomerize back to E-isomer state (step iv) is collected and/or transferred, if desired. The inducing step of step iv) can be an optically triggered crystallization.

In certain embodiments, the optically triggered crystallization can occur below room temperature. For example, the optically triggered crystallization can occur below 21° C., below 20° C., below 19° C., below 18° C., below 17° C., below 16° C., below 15° C., below 14° C., below 13° C., below 12° C., below 11° C., below 10° C., below 9° C., below 8° C., below 7° C., below 6° C., below 5° C., below 4° C., below 3° C., below 2° C., below 1° C., below 0° C., below −1° C., below −2° C., below −3° C., below −4° C., or below −5° C.

In certain embodiments, the optically triggered crystallization can be induced by exposing the Z-isomer to light in the UV- or visible spectrum.

In certain embodiments, the induced energy release by the compounds of Formula (I) is at least 50 kJ/mol or 55 kJ/mol, preferably at least 60 kJ/mol, 65 kJ/mol, 70 kJ/mol, 75 kJ/mol, 80 kJ/mol, 85 kJ/mol, or 90 kJ/mol.

Based on the foregoing, it should be apparent that it is contemplated that the method can be carried out repeatedly, with multiple cycles of the activating, storing, and inducing steps.

The compounds as defined in Formula (I) have shown the surprising combination of properties when used to carry out this method. For example, it is possible to control (i) the absorption spectrum of the compound of Formula (I) in E-isomer state; and/or (ii) the energy storage half-life of the compound of Formula (I) in Z-isomer state. Based on these combinations of unique properties, the storage devices of the invention make it possible to store energy for at least 14 days, whilst simultaneously having an absorption spectrum where the wavelength of absorption onset is of at least 300 nm.

More specifically, preferred methods of storing energy include using the compounds according to Formula (I), as herein defined, to control (i) the absorption spectrum of the compound of Formula (I), such that the compound of Formula (I) in E-isomer state exhibits wavelength absorption of between about 300 nm to about 650 nm; (ii) the energy storage half-life of the one or more compounds of Formula (I) in Z-isomer state has an energy storage half-life of at least 14 days, with a preferred energy storage half-life of at least 50 days, with a much preferred energy storage half-life of at least 100 days, with a very much preferred energy storage half-life of at least 500 days; and (iii) the compounds of Formula (I), (Ia) exhibiting release of at least 50 kJ/mol or 55 kJ/mol, preferably at least 60 kJ/mol, 65 kJ/mol, 70 kJ/mol, 75 kJ/mol, 80 kJ/mol, 85 kJ/mol, or 90 kJ/mol. Specific embodiments have achieved storage of 0.15 MJ/kg of thermal energy for weeks over a wide range of temperatures (−40° C. to +110° C.) in liquid phase.

Due to the activity of the compounds of formula (I), they have a ground state (OFF state) that is a crystalline solid. Due to exposure to light of appropriate wavelength or high temperature, the compounds of formula (I) are rendered molten, and irradiation (using light of appropriate wavelength) changes the switch to a metastable state (ON state) and “locks” the liquid phase. The step of irradiation can be carried out for a period of time sufficient to lock the liquid phase in the metastable state; typically this is from several minutes to several hours depending on the compound, the light source, and the intensity of the light. The stabilized liquid phase can then be stored for a desired period of time and allowed to cool to ambient temperature, and it can optionally be moved (e.g., via pump) from one location (where it was activated to the ON state) to another location, such as a reservoir or a location where release and heat recovery occurs. For the release, irradiation induces crystallization by changing the switch back to its ground state (i.e., turning off the switch).

In addition to the foregoing utilities described above, organic photoswitches that undergo reversible changes upon light irradiation have been integrated into various materials for applications, including light-driven actuation, drug delivery, sensing, and optical memory (Han et al., “Optically-controlled Long-term Storage and Release of Thermal Energy in Phase-change Materials,” Nature Communications 8:1446 (2017), which is hereby incorporated by reference in its entirety). These additional utilities are also contemplated for the compounds and compositions described herein.

### EXAMPLES

The examples below are intended to exemplify the practice of embodiments of the disclosure but are by no means intended to limit the scope thereof.

### Materials and Methods for Examples 1-3

Instrumentation: Thin-layer chromatography (TLC) was used to monitor reactions with Merck silica gel 60 F254 plates (0.25mm). Flash silica gel column chromatography was performed using CombiFlash RF automated flash chromatography system with Merck Silica Gel 60 (230-400 mesh). ¹H, ¹³C, and ¹⁹F NMR spectra were recorded on a Bruker Avance 400 Spectrometer at 400 MHz, 100 MHz, and 376 MHz, respectively. Tetramethylsilane (TMS) was used as an internal standard for ¹H and ¹³C spectra, and trifluoroacetic acid was used as an external standard for ¹⁹F spectra. Data recorded for NMR spectra are reported as: chemical shift (δ,), multiplicity (s, singlet; d, doublet; t, triplet; q, quartet; p, pentet; m, multiplet), integration, and coupling constant (J, Hz). High-resolution mass spectra (ESI) were recorded with a Waters Synapt G2-Si ESI mass spectrometer. High magnification images were taken with Olympus Q-Color 3 imaging system installed on the Olympus SZ-40 Stereo Microscope with Olympus SZ-PO Polarizing Lens and Schott ACE Light Source with EKE Lamp.

Differential Scanning calorimetry (DSC): DSC experiments were recorded on a DSC 250 (TA Instruments) with an RSC 90 Refrigerated Cooling System. The cooling and heating rates during DSC experiments were set to 10° C./min unless specified in figure caption. In order to measure thermal reverse isomerization, all Z isomers were heated to 190° C.

UV-Vis Absorbance Spectroscopy: All UV-Vis absorption spectra were obtained using a Varian Cary 50 UV-Vis Spectrophotometer in a UV Quartz cuvette with a path length of 10 mm. All the E isomers were dissolved in chloroform at 0.0125 mg/ml concentration. The UV-Vis spectra of the E isomers were first recorded, then the compounds were irradiated with light sources until they reached a photostationary state (PSS). LED light sources include Thorlab M395L4 (395 nm, 6.7 μW/mm²), M430L4 (430 nm, 35.3 μW/mm²), M530L3 (530 nm, 9.5 μW/mm²), M590L4 (590 nm, 6.0 μW/mm²), and M625L4 (625 nm, 21.9 μW/mm²). The fluorescence light source was a GE 13W FLE13HT3/2/SW light bulb.

Solution-State Z-Isomer Preparation: Each E isomer was dissolved in dichloromethane and irradiated with a suitable light source until PSS was reached. The solution was then concentrated and dried under high-vacuum.

Preparation of Z-Rich and E-Rich Thin Films: 5 mg of E-rich or Z-rich sample was placed on a 1″ by 1″ glass slide. Solid samples were heated above Tₘ, covered by another glass slide, then cooled to RT. Liquid samples were directly covered by another glass slide at RT. The molten solid or liquid was spread by the cover glass to fill the entire area between the glass slides. For greenhouse experiments, smaller films were made with 2 mg sample on 1.6 cm by 1.6 cm substrates to accommodate the band-pass filter coverage. A VWR Advanced hot plate stirrer was used for the stirred-irradiation process and auxiliary heating as necessary.

Selective Crystallization and Isomerization of Thin Films: To show the selective crystallization, a thin film of 1-Z was prepared according to the aforementioned method. An optical mask was placed on the film which was then irradiated with a 430 nm LED for 90 sec at RT. After the irradiation, the mask was removed, and the film was observed under an optical microscope. To show the selective isomerization of 3-E, a thin film of molten 3-E was prepared. The film was supercooled to RT, covered with a mask, and irradiated with a fluorescence light bulb for 90 min. After the irradiation, the mask was removed, and the film was observed under an optical microscope.

Measurement of % Z in Solution and Films: To determine the percentage of Z isomer (% Z) in solution, 5 mg of compound dissolved in 0.5 mL of CDCl₃ was irradiated with a light source until PSS was reached. % Z was determined by ¹H NMR. For condensed phase samples, compounds were made into films, heated above Tₘ, and irradiated with a light source until PSS was reached. The film was then dissolved in CDCl₃ for ¹H NMR analysis.

Direct Solar Irradiation: The greenhouse was constructed with a metal frame and glass walls and a black piece of paper was placed on the bottom of the greenhouse. The E-rich film was placed on the paper with a different filter covering the entire substrate. Three types of filters were used: Thorlab bandpass filter of 360 nm, 530 nm (BPF 1), 590 nm (BPF 2), 620 nm (BPF 3) (Thorlab model: FB360-10, FB530-10, FB590-10, FB620-10); Round-shaped color filter from Ultrafire A100 (green) (BPF 4); and Flexible color filter from Neewer (green, orange, red) (BPF 5, 6, 7).

The films were irradiated under each filter for 5 hours. After irradiation the material was dissolved in CDCl₃ and % Z was measured by ¹H NMR. The bulk powder isomerization was conducted with 160 mg of crystalline 1 and a stir bar added to a UV Quartz cuvette with a pathlength of 10 mm. The cuvette was placed on the black paper and a stir plate was placed under the greenhouse. The cuvette was wrapped with one layer of the flexible green filter. After 10 min, 1 was fully melted and continuously irradiated with sunlight in the greenhouse for 5 hours being stirred at 300 rpm. 5 mg aliquot of 1 was taken out for ¹H NMR analysis.

Time Dependent Isomerization: For Z-to-E isomerization, four identical Z-rich thin films of 1 were prepared. Each film was irradiated with 430 nm light at RT for 20, 40, 80, and 160 s, respectively. The percentage of Z-isomers were measured using ¹H NMR. For E-to-Z isomerization, seven identical E rich thin films of 1 were prepared. Each film was irradiated with 530 nm light at 50° C. for 1, 2, 3, 4, 5, 10, and 20 min, respectively. The percentage of Z-isomers were measured using ¹H NMR. To determine the heat storage time, the identical procedure was carried out to prepared liquid Z samples that were monitored in dark until crystallization occurred.

Measurement of Emission Spectrum, Irradiation Power, and Substrate Transmission: The emission spectrum of the fluorescence light bulb was measured with a Shimadzu RF-5301 Fluorimeter, following the procedure from Shimadzu “Measurement of Emission Spectra of LED Light Bulbs,” Application News No. A497, Shimadzu Corporation (2015), accessed at www.shimadzu.com (December 2020), which is hereby incorporated by reference in its entirety. The irradiation power of various light sources was measured using a Thorlab PM160T Thermal Sensor Power Meter at the wavelength of maximum output intensity. The transmission spectra of substrates were measured with a Varian Cary 50 UV-Vis Spectrophotometer.

Rheology Measurements of Compound 1: The strain sweep measurement was conducted using a TA Instruments ARES-G2 rheometer with Parallel Plate System. The strain sweep was measured at angular frequency of 6.28 rad/s at RT for 290 s, except for 1-E which was measured at 45° C. The gap between plates was 0.4 mm for all measurements.

IR Images: All IR images were recorded at 1 frame/sec with Avio InfRec R⁴⁵⁰P IR camera equipped with a standard lens, capable of measuring from −40 to 120° C. At RT, a stir bar and 160 mg of 1 were placed in a UV Quartz cuvette with a pathlength of 10 mm. The cap of the cuvette was removed, and the IR camera was set on top of the cuvette to record the top-down view of samples in the cuvette through the top opening. 430 nm LED was placed 20 cm away from the side of the cuvette, irradiating directly on the substrate.

### Example 1—Synthesis and Characterization of Azobenzene Intermediates 1′-4′ and Compounds 1-5

Azobenzene intermediates 1′-4′ and compounds 1-5 were synthesized using the scheme shown and described below. The intermediates and compounds were characterized by spectroscopic analyses.

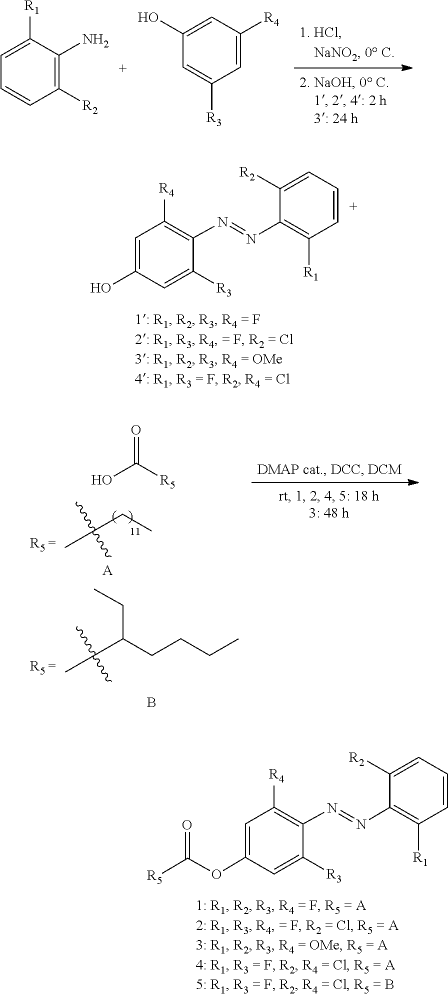

### Synthesis of (E)-4((2,6-Difluorophenyl)diazenyl)-3,5-difluorophenol (Compound 1′)

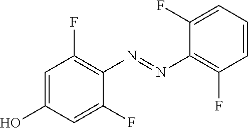 [SMILES: Oc1cc(F)c(/N=N/c2c(F)cccc2F)c(F)c1]

To the mixture of 2,6-difluoro aniline (0.387 g, 3 mmol, 1 eq) and 7.5 mL of D.I. water, 1.05 mL of the concentrated hydrochloric acid was added. The mixture was stirred and cooled to 0° C. with an ice bath. A solution of sodium nitrite (0.249 g, 3.3 mmol, 1.1 eq) and water (4.5 mL) was added dropwise between 0° C.-4° C. The orange suspension was then added to a solution of 3.5-difluoro phenol (0.429 g, 3.3 mmol, 1.1 eq), sodium hydroxide (0.4 g, 10 mmol, 3.3 eq), and water (6 mL) dropwise at 0° C. The suspension was allowed to stir at 0° C. for 2 hours. To the reaction mixture, 0.5 M hydrochloric acid was added until pH 2 was reached. The mixture was extracted with dichloromethane (30 mL, three times), and the organic layer was collected, washed with brine, dried over anhydrous MgSO₄, and concentrated on a rotary evaporator. The residue was purified with flash silica gel chromatography (30% ethyl acetate in hexanes). The product was isolated as an orange solid (370 mg, 46%). ¹H NMR spectra matched reported value (Li et al., “Smart Azobenzene-Containing Tubular Polymersomes: Fabrication and Multiple Morphological Tuning,” Chem. Commun. 56:6237-6240 (2020), which is hereby incorporated by reference in its entirety).

### Synthesis of (E)-4((2,6-Difluorophenyl)diazenyl)-3,5-difluorophenyl Tridecanoate (Compound 1)

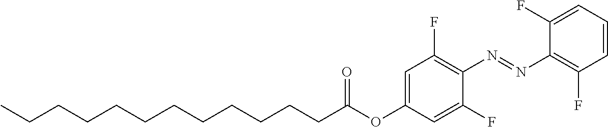 [SMILES: CCCCCCCCCCCCC(=O)Oc1cc(F)c(/N=N/c2c(F)cccc2F)c(F)c1]

Compound 1′ (270 mg, 1 mmol, 1 eq), tridecanoic acid (214 mg, 1 mmol, 1 eq), N,N′-dicyclohexylcarbodiimide (206 mg, 1 mmol, 1 eq), and 4-dimethylaminopyridine (15 mg, 0.15 mmol, 0.15 eq) were dissolved in dichloromethane (47 mL). The solution was allowed to stir at RT for 18 hours. Then, hexane (47 mL) was added, and the reaction mixture was cooled in the freezer over night at −20° C. The white precipitate was filtered off using vacuum filtration and washed serval times with cold hexane. The filtrate was then concentrated and dried under high vacuum. The residue was purified with flash silica gel chromatography (5% ethyl acetate in hexanes). The final product was obtained as an orange solid (373 mg, 80%).

The structure of the Compound 1 was confirmed by spectroscopic analysis. ¹H NMR NMR: (400 MHz, Chloroform-d) δ 7.36 (m, 1H, ArH), 7.06 (t, J=8.58 Hz, 2H, ArH), 6.91 (d, J=9.56 Hz, 2H, ArH), 2.58 (t, J=7.55 Hz, 2H, CH₂COO), 1.65 (p, J=7.50 Hz, 2H, CH₂CH₂COO), 1.46-1.18 (m, 18H, CH₂CH₂), 0.88 (t, J=7.09 Hz, 3H, CH₂CH₃). ¹³C NMR: (100 MHz, Chloroform-d) δ 170.93, 155.90 (dd, J=262.80, 6.30 Hz), 155.55 (dd, J=260.84, 4.08 Hz), 152.47 (t, J=13.76 Hz), 131.76 (t, J=10.00 Hz), 131.36 (t, J=10.37 Hz), 129.41 (t, J=10.00 Hz), 112.57 (dd, J=19.58, 4.80 Hz), 112.56 (dd, J=20.99, 3.0 Hz), 106.83 (dd, J=23.82, 3.90 Hz), 34.25, 31.88, 29.61, 26.60, 29.55, 29.39, 29.32, 29.18, 28.99, 24.66, 22.65, 14.07. ¹⁹F NMR: (376 MHz, Chloroform-d) δ −118.56 (d, J=9.59 Hz, 2F, ArF), −121.22 (dd, J=10.13, 6.04 Hz, 2F, ArF). HRMS (ESI): m/z calculated for C₂₅H₃₀F₄N₂O₂ [M+H]⁺ 467.2322, found 467.2319

### Synthesis of (E)-4-((2-Chloro-6-fluorophenyl)diazenyl)-3,5-difluorophenol (Compound 2′)

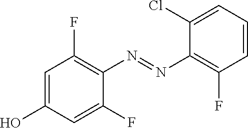 [SMILES: Oc1cc(F)c(/N=N/c2c(F)cccc2Cl)c(F)c1]

Compound 2′ was prepared using the same procedure as described above for the synthesis of compound 1′ and using 2-chloro-6-fluoroaniline and 3,5-difluorophenol as starting materials at 3 mmol/eq scale. The final product was obtained as an orange solid (302 mg, 34.9%).

The structure of the Compound 2′ was confirmed by spectroscopic analysis. ¹H NMR NMR: (400 MHz, Dichloromethane-d₂) δ 7.40-7.20 (m, 2H, ArH), 7.15 (t, J=9.04 Hz, 1H, ArH), 6.57 (d, J=11.31 Hz, 2H, ArH). ¹⁹F NMR: (376 MHz, Dichloromethane-d₂) δ −117.81 (s, 2F, ArF), −125.81 (s, 1F, ArF). HRMS (ESI): m/z calculated for C₁₂H₆ClF₃N₂O [M+H]⁺ 287.0199, found 287.0200.

### Synthesis of (E)-4-((2-Chloro-6-fluorophenyl)diazenyl)-3,5-difluorophenyl Tridecanoate (Compound 2)

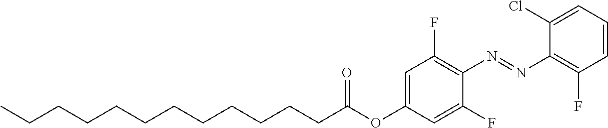 [SMILES: CCCCCCCCCCCCC(=O)Oc1cc(F)c(/N=N/c2c(F)cccc2Cl)c(F)c1]

Compound 2 was prepared using the same procedure as described above for the synthesis of compound 1 and using 2′ and tridecanoic acid as starting materials at 0.36 mmol/eq scale. The final product was obtained as an orange solid (124 mg, 69%).

The structure of the Compound 2 was confirmed by spectroscopic analysis. ¹H NMR: (400 MHz, Dichloromethane-d₂) δ 7.42-7.29 (m, 2H, ArH), 7.18 (t, J=9.89 Hz, 2H, ArH), 6.96 (d, J=10.36 Hz, 2H, ArH), 2.59 (t, J=7.49 Hz, 2H, CH₂COO), 1.75 (p, J=7.33 Hz, 2H, CH₂CH₂COO), 1.50-1.23 (m, 18H, CH₂CH₂), 0.90 (t, J=6.35 Hz, 3H, CH₂CH₃). ¹³C NMR: (100 MHz, Chloroform-d) δ 170.94, 155.99 (dd, J=261.84, 6.23 Hz), 153.00 (t, J=14.00 Hz), 152.49 (d, J=260.52 Hz), 139.73 (d, J=9.53 Hz), 131.66 (d, J=2.81 Hz), 130.60 (d, J=9.58 Hz), 128.90 (t, J=9.82 Hz), 126.15 (d, J=3.78 Hz), 115.77 (d, J=20.65 Hz), 106.94 (dd, J=23.65, 3.77 Hz), 34.16, 31.89, 29.61, 29.60, 29.55, 29.40, 29.32, 29.18, 24.61, 22.65, 13.83. ¹⁹F NMR: (376 MHz, Dichloromethane-d₂) δ −118.97 (d, J=10.29 Hz, 2F, ArF), −125.04 (dd, J=10.69, 5.31 Hz, 1F, ArF). HRMS (ESI): m/z calculated for C₂₅H₃₀ClF₃N₂O₂ [M+H]⁺ 483.2026, found 483.2025.

### Synthesis of (E)-4((2,6-Dimethoxyphenyl)diazenyl)-3,5-dimethoxyphenol (Compound 3′)

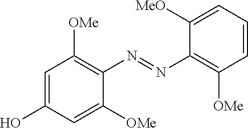 [SMILES: COc1cccc(OC)c1/N=N/c1c(OC)cc(O)cc1OC]

The compound was synthesized using a reported procedure at the twice scale (Weis et al., “Visible-Light-Responsive Azopolymers with Inhibited π-π Stacking Enable Fully Reversible Photopatterning,” Macromolecules 49:6368-6373 (2016), which is hereby incorporated by reference in its entirety). The final product was obtained as an orange solid (0.573 g, 46%). The ¹H NMR spectra matched the one reported in the literature (Weis et al., “Visible-Light-Responsive Azopolymers with Inhibited π-π Stacking Enable Fully Reversible Photopatterning,” Macromolecules 49:6368-6373 (2016), which is hereby incorporated by reference in its entirety).

### Synthesis of (E)-4((2,6-Dimethoxyphenyl)diazenyl)-3,5-dimethoxyphenyl Tridecanoate (Compound 3)

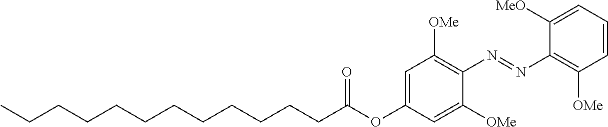 [SMILES: CCCCCCCCCCCCC(=O)Oc1cc(OC)c(/N=N/c2c(OC)cccc2OC)c(OC)c1]

Compound 3 was prepared using the same procedure as described above for the synthesis of compound 1 and using 3′ and tridecanoic acid as starting materials at 1.80 mmol/eq scale. The reaction was stirred for 48 hours. The final product was obtained as an orange solid (747 mg, 78%).

The structure of the Compound 3 was confirmed by spectroscopic analysis. ¹H NMR: (400 MHz, Chloroform-d) δ 7.19 (t, J=8.40 Hz, 1H, ArH), 6.64 (d, J=8.47 Hz, 2H, ArH), 6.42 (s, 2H, ArH), 3.82 (s, 6H, OCH₃), 3.81 (s, 6H, OCH₃), 2.54 (t, J=7.59 Hz, CH₂COO), 1.74 (p, J=7.53 Hz, 2H, CH₂CH₂COO), 1.46-1.18 (m, 18H, CH₂CH₂), 0.86 (t, J=6.59 Hz, 3H, CH₂ CH₃). ¹³C NMR: (100 MHz, Chloroform-d) δ 171.86, 152.96, 152.27, 151.71, 134.55, 131.99, 129.19, 105.17, 99.04, 56.61, 56.54, 34.43, 31.88, 29.63, 29.60, 29.58, 29.44, 29.32, 29.24, 29.12, 24.81, 22.65, 14.08. HRMS (ESI): m/z calculated for C₂₉H₄₂N₂O₆ [M+H]⁺ 515.3121, found 515.3120.

### Synthesis of (E)-3-Chloro-4-((2-chloro-6-fluorophenyl)diazenyl)-5-fluorophenol (Compound 4′)

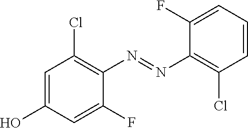 [SMILES: Oc1cc(F)c(/N=N/c2c(F)cccc2Cl)c(Cl)c1]

Compound 4′ was prepared using the same procedure as described above for the synthesis of compound 1′ and using 2-chloro-6-fluoroaniline and 3-chloro-5-fluorophenol as starting materials at 3 mmol/eq scale. The final product was obtained as an orange solid (333 mg, 37%).

The structure of the Compound 4′ was confirmed by spectroscopic analysis. ¹H NMR: (400 MHz, Dichloromethane-d₂) δ 7.43-7.25 (m, 2H, ArH), 7.16 (t, J=9.89 Hz, 1H, ArH), 6.92 (s, 1H, ArH), 6.66 (d, J=12.53 Hz, 2H, ArH). ¹⁹F NMR: (376 MHz, Dichloromethane-d₂) δ −119.835 (d, J=11.32 Hz, 1F, ArF), −125.24 (s, 1F, ArF). HRMS (ESI): m/z calculated for C₁₂H₆Cl₂F₂N₂O [M+H]⁺ 302.9903, found 302.9906.

### Synthesis of (E)-3-chloro-4-((2-chloro-6-fluorophenyl)diazenyl)-5-fluorophenyl Tridecanoate (Compound 4)

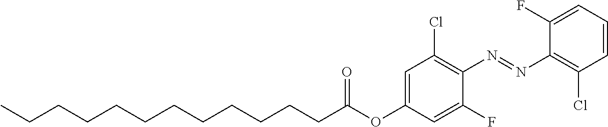 [SMILES: CCCCCCCCCCCCC(=O)Oc1cc(F)c(/N=N/c2c(F)cccc2Cl)c(Cl)c1]

Compound 4 was prepared using the same procedure as described above for the synthesis of compound 1 and using 4′ and tridecanoic acid as starting materials at 0.5 mmol/eq scale. The final product was obtained as an orange solid (219 mg, 88%).

The structure of the Compound 4 was confirmed by spectroscopic analysis. ¹H NMR: (400 MHz, Dichloromethane-d₂) δ 7.42-7.32 (m, 2H, ArH), 7.24-7.15 (m, 2H, ArH), 7.03 (dd, J=11.38, 2.36 Hz, 1H, ArH), 2.59 (t, J=7.52 Hz, 2H, CH₂COO), 1.74 (p, J=7.49 Hz, 2H, CH₂CH₂COO), 1.46-1.21 (m, 18H, CH₂CH₂), 0.88 (t, J=6.35 Hz, 3H, CH₂CH₃). ¹³C NMR: (100 MHz, Dichloromethane-d₂) δ 171.06, 152.65 (d, J=263.53 Hz), 152.48 (d, J=260.89 Hz), 151.81 (d, J=12.50 Hz), 139.38 (d, J=9.50 Hz), 136.82 (d, J=9.17 Hz), 133.11 (d, J=4.70 Hz), 131.84 (d, J=2.67 Hz), 130.50 (d, J=9.54 Hz), 126.19 (d, J=3.83 Hz), 119.76 (d, J=3.85 Hz), 115.79 (d, J=20.69 Hz), 110.14 (d, J=23.76 Hz), 34.13, 31.90, 29.62, 29.61, 29.56, 29.41, 29.33, 29.19, 28.97, 24.64, 22.66, 13.85. ¹⁹F NMR: (376 MHz, Dichloromethane-d₂) δ −121.515 (d, J=11.53 Hz, 1F, ArF), −124.503 (dd, J=10.56, 4.85 Hz, 1F, ArF). HRMS (ESI): m/z calculated for C₂₅H₃₀Cl₂F₂N₂O₂ [M+H]⁺ 499.1731, found 499.1725.

### Synthesis of (E)-3-Chloro-4-((2-chloro-6-fluorophenyl)diazenyl)-5-fluorophenyl-2-ethylhexanoate (Compound 5)

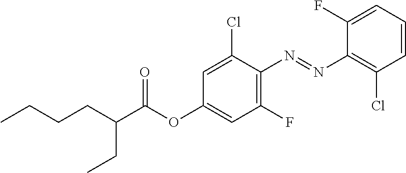 [SMILES: CCCCC(CC)C(=O)Oc1cc(F)c(/N=N/c2c(F)cccc2Cl)c(Cl)c1]

Compound 5 was prepared using the same procedure as described above for the synthesis of compound 1 and using compound 4′ and 2-ethylhexanoic acid as starting materials at 0.25 mmol/eq scale. The final product was obtained as a dark red oil (100 mg, 93%).

The structure of the Compound 5 was confirmed by spectroscopic analysis. ¹H NMR: (400 MHz, Dichloromethane-d₂) δ 7.44-7.31 (m, 2H, ArH), 7.25-7.15 (m, 2H, ArH), 7.02 (dd, J=11.441, 2.00 Hz, 1H, ArH), 2.55 (m, 1H, CHCOO), 1.85-1.57 (m, 4H, CH₂CHCH₂), 1.45-1.31 (m, 4H, CH₂ CH₃), 1.02 (t, J=7.50 Hz, 3H, CH₂ CH₃), 0.94 (t, J=6.82 Hz, 3H, CH₂ CH₃). ¹³C NMR: (100 MHz, Dichloromethane-d₂) δ 173.64, 152.66 (d, J=263.24 Hz), 152.48 (d, J=261.08 Hz), 151.89 (d, J=12.46 Hz), 139.37 (d, J=9.71 Hz), 136.83 (d, J=9.41 Hz), 133.11 (d, J=4.70 Hz), 131.82 (d, J=2.78 Hz), 130.86 (d, J=9.51 Hz), 126.19 (d, J=3.75 Hz), 119.82 (d, J=3.84 Hz), 115.79 (d, J=20.55 Hz), 110.20 (d, J=23.62 Hz), 47.23, 31.46, 29.51, 25.26, 22.56, 13.65, 11.53. ¹⁹F NMR: (376 MHz, Dichloromethane-d₂) δ -121.490 (d, J=11.50 Hz, 1F, ArF), −124.450 (m 1F, ArF). HRMS (ESI): m/z calculated for C₂₀H₂₀Cl₂F₂N₂O₂ [M+H]⁺ 429.0948, found 429.0942.

### Example 2—Solar Irradiance Calculation

To estimate the solar radiant flux on the sample (1″ by 1″ film) in the green house the following equation was used:

Φₑ=Eₑ×A% T_{BPF}×% T_{greenhouse}×%T_{glassSlide} (Eq. 1)

where Φₑ is the radiant flux, Eₑ is the integrated irradiance of a certain range of wavelengths, A is the area of sample, and % T is the % transmission of bandpass filter, greenhouse ceiling, or the cover glass slide at the wavelengths.
Φ₃₆₀=0.66 mW
Φ₄₃₀=2.10 mW
Φ₅₃₀=3.65 mW (BPF 1)
Φ₅₉₀=3.90 mW (BPF 2)
Φ₆₂₅=3.80 mW (BPF 3)
Φ₅₃₀=6.23 mW (BPF 4)
   To estimate the radiant flux on the sample (1″ by 1″ film) irradiated with an LED the following equation was used:

Φ_{LED}=E_{LED}×% T_{glassSlide} (Eq. 2)

where Φ_{LED} is the radiant flux, E_{LED} is the irradiance of the LED, and % T_{glassSlide} is the % transmission of the cover glass slide used for the thin film sample.
E₄₃₀LED=54.45 mW; Φ_{430LED}=50.09 mW
E₅₃₀LED=13.12 mW; Φ_{530LED}=12.07 mW
E₅₉₀LED=7.74 mW; Φ_{590LED}=7.12 mW
E₆₂₅LED=25.60 mW; Φ_{625LED}=25.55 mW
   For the fluorescence light bulb:
E₆₁₀ₙₘ=10.26 mW; Φ₆₁₀ₙₘ=9.44 mW

### Example 3—Calculation of Energy Conversion Efficiency (ECE)

ECE can be defined using the following equation:

$$η = \frac{{E}_{output}}{{E}_{input}} \qquad ( Eq . 3 )$$

where Eᵢₙₚᵤₜ is the total energy input and Eₒᵤₜₚᵤₜ is the total energy output of the storage system. Considering only thermal energy input (Eᵢₙₚᵤₜ=ΔHₘ) and output (Eₒᵤₜₚᵤₜ=ΔHᵢₛₒ+ΔH_{c}),

$$η = \frac{Δ {H}_{iso} \times \% Iso + Δ {H}_{c} ( E ) \times \% E}{Δ {H}_{m} ( E )} \qquad ( Eq . 4 )$$

where ΔH_{c} and ΔHₘ are the crystallization and melting enthalpy of E isomers, respectively. % Iso is the percentage change of Z-isomer during the Z-to-E isomerization. % E is the percentage of final E-isomer concentration upon the Z-to-E isomerization and crystallization.

Compound 1 shows % Iso=76% and % E=91% upon triggered crystallization, thus efficiency (η) was calculated as: η=130.8%. Considering the additional photon energy required for triggering Z-to-E photoisomerization,

$$η = \frac{Δ {H}_{iso} \times \% Iso + Δ {H}_{c} ( E ) \times \% E}{Δ {H}_{m} ( E ) + \frac{{E}_{Z - E}}{{Φ}_{Z - E}} \times \% Iso} \qquad ( Eq . 5 )$$

where E_{Z-E} is the photon energy used for Z-to-E isomerization and Φ_{Z-E} is the quantum yield of the process. Using photon energy at 430 nm and Φ_{Z-E} of 0.49 (Knie et al., “ortho-Fluoroazobenzenes: Visible Light Switches with Very Long-Lived Z Isomers,” Chem. Eur. J. 20:16492-16501 (2014), which is hereby incorporated by reference in its entirety), the efficiency (ii) was calculated as: η=13.3%.

Considering the photon energy required for E-to-Z photoisomerization,

$$η = \frac{Δ {H}_{iso} \times \% Iso + Δ {H}_{c} ( E ) \times \% E}{Δ {H}_{m} ( E ) + \frac{{E}_{Z - E}}{{Φ}_{Z - E}} \times \% Iso + \frac{{E}_{E - Z}}{{Φ}_{E - Z}} \times \% Iso} \qquad ( Eq . 6 )$$

where E_{E-Z} is the photon energy of used for E-to-Z isomerization and Φ_{E-Z} is the quantum yield of the process. Using photon energy at 530 nm and Φ_{E-Z} of 0.3 (Knie et al., “ortho-Fluoroazobenzenes: Visible Light Switches with Very Long-Lived Z Isomers,” Chem. Eur. J. 20:16492-16501 (2014), which is hereby incorporated by reference in its entirety), the efficiency (η) was calculated as: η=6.05%.

Considering a facile E-to-Z isomerization reaching a PSS and incomplete Z-to-E reverse isomerization during crystallization,
when % Iso=68% & % E=83%: η=6.09%
when % Iso=46% & % E=61%: η=6.28%
when % Iso=37% & % E=52%: η=6.42%.

Considering an incomplete E-to-Z isomerization and a facile Z-to-E reverse isomerization reaching a PSS,
when % Iso=66% & % E=91%: η=6.60%
when % Iso=56% & % E=91%: η=7.33%
when % Iso=46% & % E=91%: η=8.35%.

### Discussion of Examples 1-3

The photo-controlled phase change materials (PCMs) reported so far have a common molecular structure, i.e. a photo-switch head group linked to an aliphatic tail. This structure creates the balance between the 90 -π interaction among the head groups and the London dispersion forces among the tail groups. Such a molecular design allows for the phase transition of molecules, mainly controlled by the conformational change of photo-switches between planar and non-planar geometries and the altered degree of head group interactions. In the recent works that demonstrated the concept of photo-controlled heat storage in organic PCMs, the crystalline PCMs were irradiated with strong UV light using an arc lamp or an LED to undergo photo-switching and simultaneous melting (Zhang et al., “Photochemical Phase Transitions Enable Coharvesting of Photon Energy and Ambient Heat for Energetic Molecular Solar Thermal Batteries That Upgrade Thermal Energy,” J. Am. Chem. Soc. 142:12256-12264 (2020); Gerkman et al., “Arylazopyrazoles for Long-Term Thermal Energy Storage and Optically Triggered Heat Release below 0° C.,” J. Am. Chem. Soc. 142:8688-8695 (2020); Han et al., “Optically-Regulated Thermal Energy Storage in Diverse Organic Phase-Change Materials,” Chem. Commun. 54:10722-10725 (2018); Han et al., “Optically-Controlled Long-Term Storage and Release of Thermal Energy in Phase-Change Materials,” Nat. Commun. 8:1446 (2017), which are hereby incorporated by reference in their entirety). Occasionally, the photo-thermal effect of strong UV irradiation promoted the direct photo-melting, while other times external thermal energy input was required to pre-melt the crystalline PCMs to allow for the facile conformational change of the photo-switches. The resulting liquid PCMs have shown a remarkable stability over a large window of temperatures such as −30° C. to 60° C. (Gerkman et al., “Arylazopyrazoles for Long-Term Thermal Energy Storage and Optically Triggered Heat Release below 0° C.,” J. Am. Chem. Soc. 142:8688-8695 (2020), which is hereby incorporated by reference in its entirety), enabling the long-term storage of latent heat (i.e. a few weeks) in the photo-activated liquid and the triggered release of the stored heat by optical stimulation within a visible-light range.

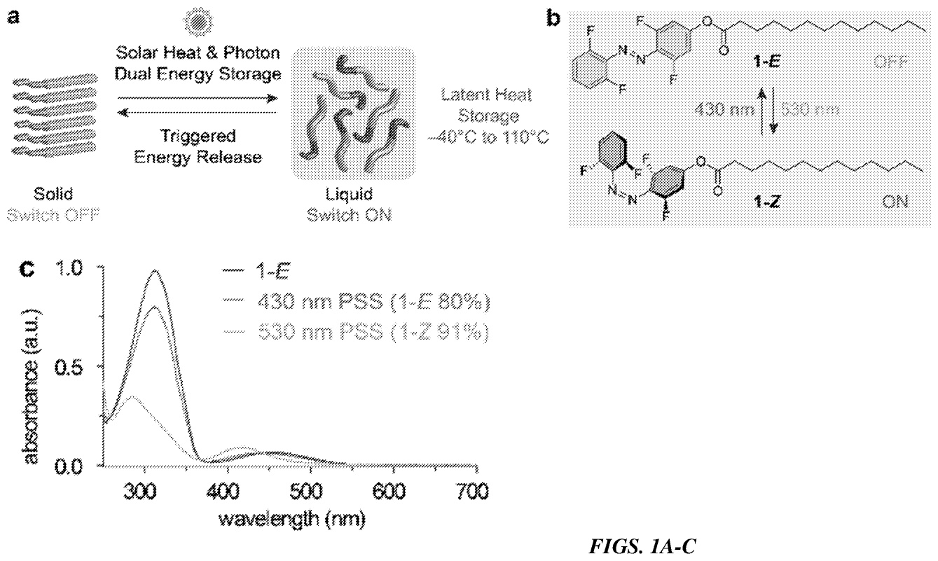

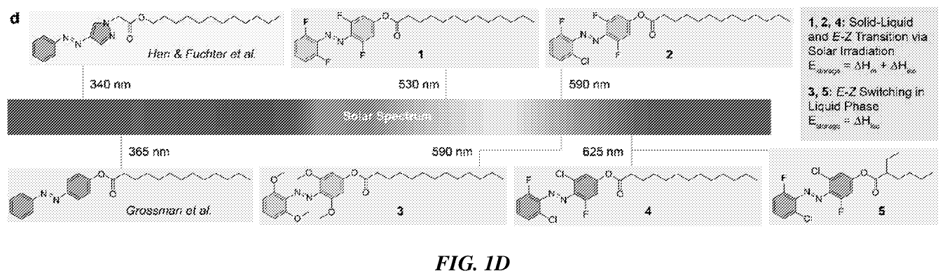

A new material system that directly harnesses solar heat and photon without any external light source or heat source is shown in FIG. 1A. The organic PCMs containing planar photo-switches in the ground state (OFF state) initially formed crystalline solid that absorbed solar thermal energy and isomerized by solar photons to result in a liquid phase. The liquid PCMs consisting of non-planar photo-switches in the metastable state (ON state) can be preserved over a substantial range of temperatures, −40° C. to 110° C., until the optical triggering immediately crystallized the PCMs to release the latent heat. FIG. 1B shows the structural change of a photo-switchable PCM molecule incorporating a novel head group, o-fluoroazobenzene, and a fatty ester tail. The red-shifted n-π* absorption band of such a planar isomer (1-E) that extends beyond 500 nm (FIG. 1C) enables the photo-activation of E switches by visible light (i.e. 530 nm in the case of compound 1), accompanying a substantial E-to-Z conversion of 91% at the photostationary state. The Z-to-E reversion was triggered by 430 nm which activated the n-π* transition of 1-Z isomer and rapidly restored 80% 1-E. Z isomer of o-fluoroazobenzene presents a significant half-life (ca. 700 days for pristine) (Bléger et al., “o-Fluoroazobenzenes as Readily Synthesized Photoswitches Offering Nearly Quantitative Two-Way Isomerization with Visible Light,” J. Am. Chem. Soc. 134:20597-20600 (2012), which is hereby incorporated by reference in its entirety) due to thermal stability of the metastable state.

FIG. 1D illustrates the wavelengths of light that induces E-to-Z isomerization of each azobenzene derivative shown. The pristine azobenzene functionalized with a tridecanoate chain is primarily activated by 365 nm irradiation, as previously reported by Grossman and coworkers in their first demonstration of photo-controlled latent heat storage in organic PCMs (Han et al., “Optically-Controlled Long-Term Storage and Release of Thermal Energy in Phase-Change Materials,” Nat. Commun. 8:1446 (2017), which is hereby incorporated by reference in its entirety). Arylazopyrazole derivatives reported by Gerkman et al., “Arylazopyrazoles for Long-Term Thermal Energy Storage and Optically Triggered Heat Release below 0° C.,” J. Am. Chem. Soc. 142:8688-8695 (2020), which is hereby incorporated by reference in its entirety, showed the most facile E-to-Z switching by 340 nm activation. Another class of arylazopyrazoles functionalized with alkyl ether groups responded to 365 nm as reported by Zhang et al., “Photochemical Phase Transitions Enable Coharvesting of Photon Energy and Ambient Heat for Energetic Molecular Solar Thermal Batteries That Upgrade Thermal Energy,” J. Am. Chem. Soc. 142:12256-12264 (2020), which is hereby incorporated by reference in its entirety. As all of the reported photo-switchable PCMs require a high-intensity UV light source for initial activation, which is not achieved by direct solar irradiation, a new series of molecules that undergo E-to-Z isomerization by visible light irradiation were developed.

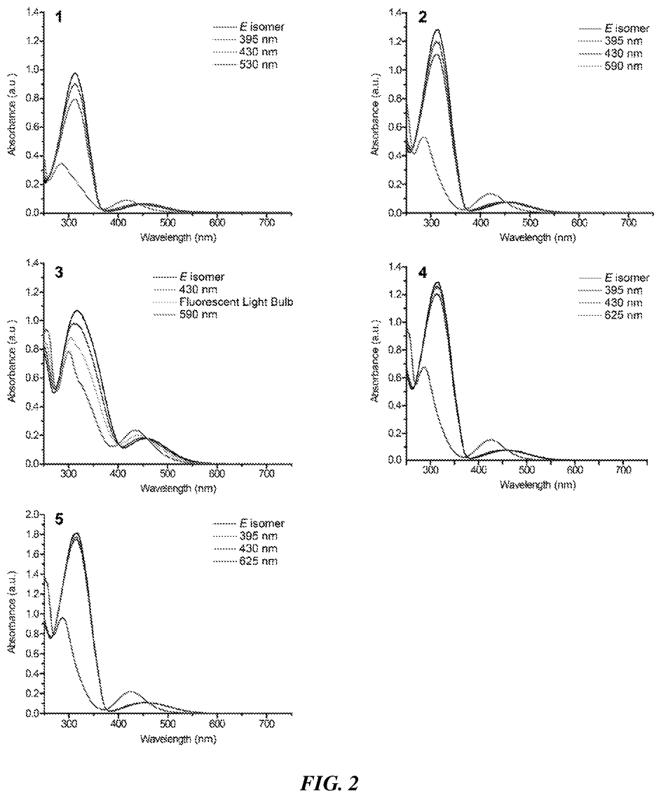

Five compounds were designed and synthesized. These compounds demonstrated the viability of sunlight-driven molecular isomerization and concomitant crystal-to-liquid phase transition (compounds 1, 2, and 4), which led to the storage of both isomerization energy and latent heat. This class of compounds displayed a unique phase in each isomeric state (E or Z), exhibiting a phase transition upon photo-induced structural isomerization. A different class of switches (compounds 3 and 5) that undergo a same-phase photo-switching under sunlight and store the isomerization energy was also identified. The respective UV-Vis absorption spectra of all compounds in E and Z isomeric forms are shown in FIG. 2.

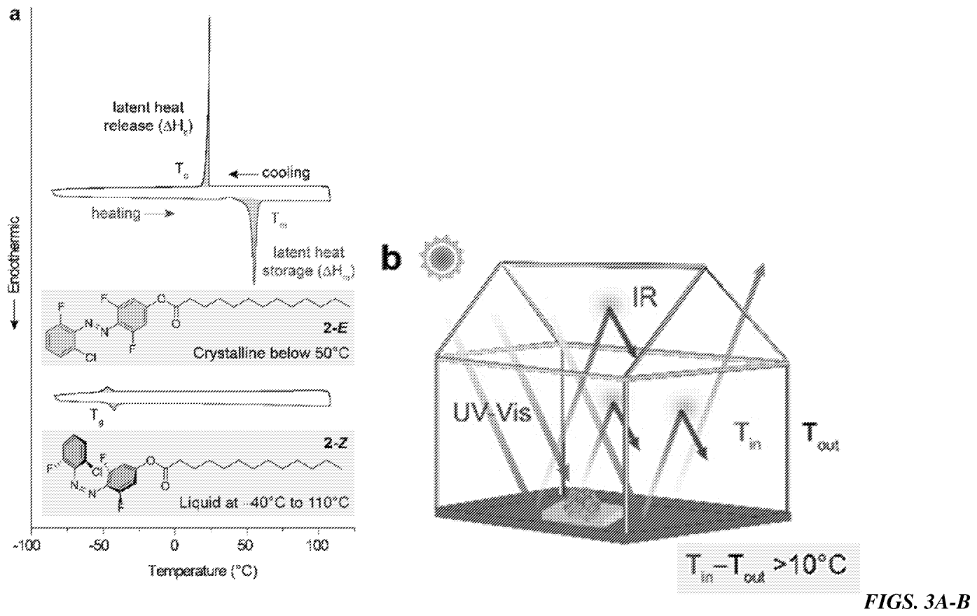

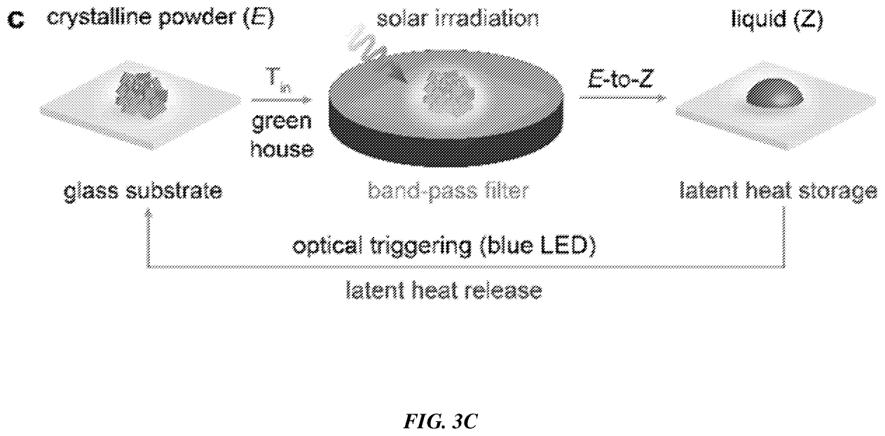

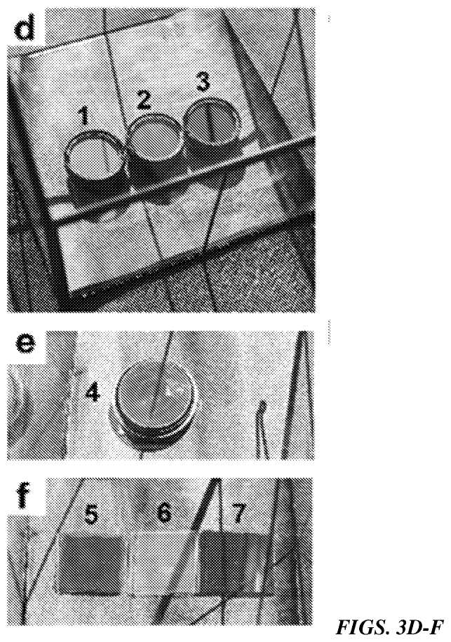

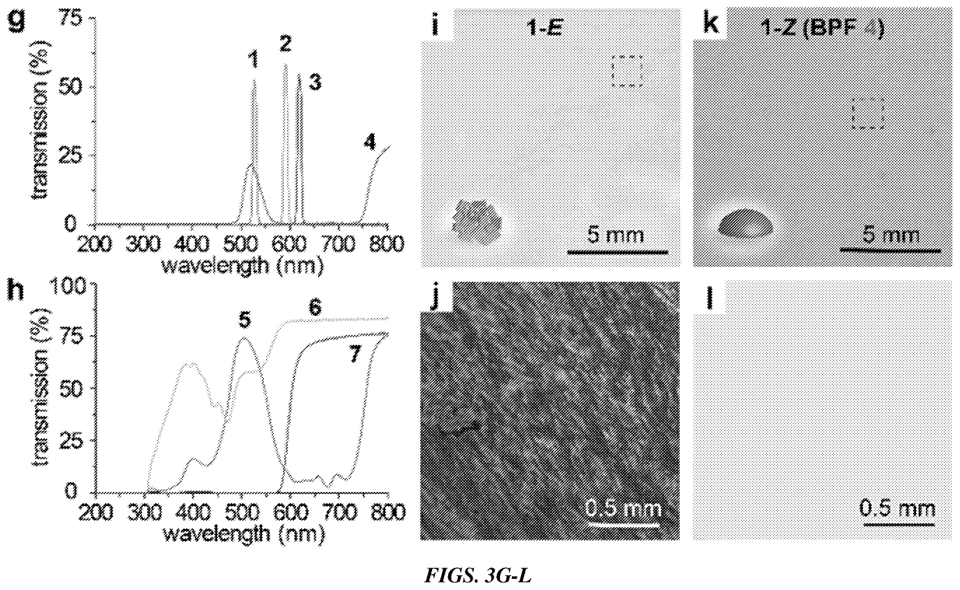

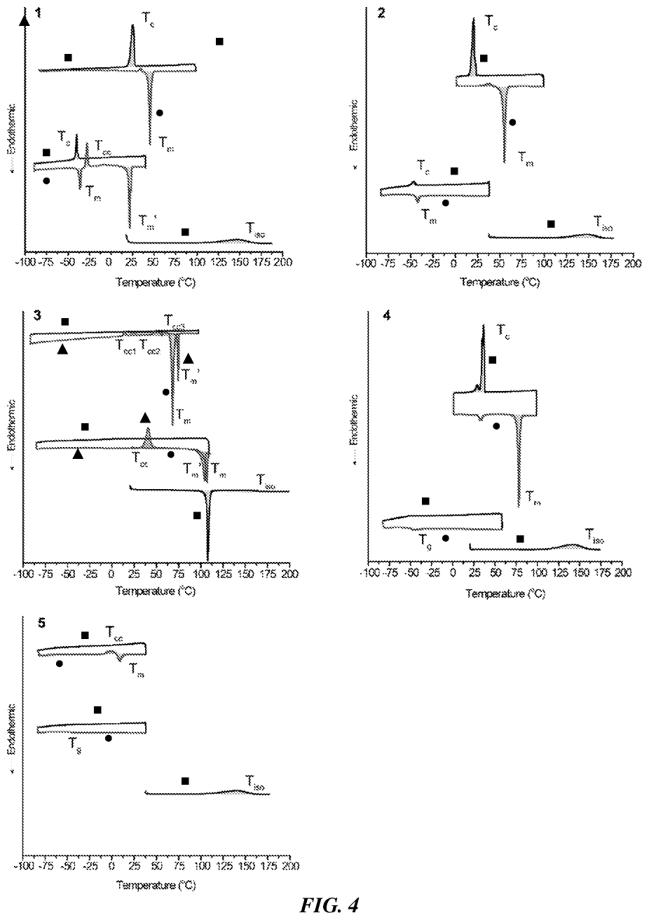

The distinct phases of E and Z isomer of compounds 1, 2, and 4 are exemplified by differential scanning calorimetry (DSC) in FIG. 3A. The E isomer of the compounds exhibited clear melting and crystallization peaks that correspond to large latent heat absorption and release processes. The Z isomer of compound 2, on the other hand, showed a stable liquid phase between −40° C. and 110° C., a large window of temperatures defined by the partial crystallization point at the low end and by the onset of thermal reverse isomerization (Z-to-E) at the high end. All DSC traces of compounds 1-5 as E and Z forms were recorded to monitor their phase transitions and thermal isomerization as shown in FIG. 4. All thermal parameters including the melting temperature, melting enthalpy (i.e. heat of fusion), crystallization temperature, crystallization enthalpy, glass transition temperature, isomerization onset temperature, and isomerization enthalpy were summarized for all compounds and are shown in Tables 1 and 2. In contrast to compounds 1, 2, and 4, the other two compounds 3 and 5 exhibited a same-phase E-Z isomerization due to the similar phase characteristics of E and Z isomers. The DSC traces of compound 3 as both E and Z forms showed the extensive supercooling of the molten phase to −80° C. Therefore, the photo-induced E-Z isomerization occurs in a supercooled liquid phase at room temperature. The Z liquid phase is more stable than E liquid at room temperature: the cold-crystallization temperature of Z isomer is 41° C., while that of E isomer is 16° C. Compound 5 was intrinsically liquid at room temperature as synthesized, and both E and Z isomers remained liquid even at −80° C. The E isomer showed minor cold-crystallization at −1° C. but immediately recovered the liquid phase at 9° C. Thus, compounds 5 undergoes an unhindered E-Z photo-switching in the liquid phase at room temperature.

TABLE 1
Phase Transition Parameters of E and Z-Isomers Measured by DSC

| | E | | | | Z | | | |
|---|---|---|---|---|---|---|---|---|
| | Tₘ | ΔHₘ | T_{c} | ΔH_{c} | Tₘ | ΔHₘ | T_{c} | ΔH_{c} |
| | (° C.) | (kJ/mol) | (° C.) | (kJ/mol) | (° C.) | (kJ/mol) | (° C.) | (kJ/mol) |
| 1 | 45 | 48 | 25 | 45 | −36 | 11 | −40 | 13 |
| | | | | | 22′ | 35′ | −28^{cc} | 16^{cc} |
| 2 | 56 | 47 | 21 | 43 | −42 | 6 | −47 | 4 |
| 3 | 70 | 60 | 16^{cc1} | 6^{cc1} | 106 | 39 | 41^{cc} | 340^{cc} |
| | 76′ | 34′ | 50^{cc2} | 19^{cc2} | 104′ | 29′ | | |
| | | | 58^{cc3} | 10^{cc3} | | | | |
| 4 | 78 | 38 | 37 | 37 | Liq | Liq | Liq | Liq |
| 5 | 9 | 5 | −1^{cc} | 7 | Liq | Liq | Liq | Liq |

Peak temperature of each thermal transition is reported. Cold-crystallization peak (^{cc}), second melting peak (′), melting enthalpy (ΔHₘ), and crystallization enthalpy (ΔH_{c}).

TABLE 2
Thermal Parameters of Z-Isomers Obtained From
the Complete Thermal Reversion Processes

| | Tᵢₛₒ | ΔHᵢₛₒ | ΔH_{c} | ΔHₜₒₜₐₗ |
|---|---|---|---|---|
| | (° C.) | (kJ/mol) | (kJ/mol) | (kJ/mol) |
| 1 | 114 | 25 | 45 | 70 |
| 2 | 114 | 23 | 43 | 66 |
| 3 | 120 | 6 | 35 | 41 |
| 4 | 109 | 25 | 37 | 62 |
| 5 | 105 | 21 | 7 | 28 |

Tᵢₛₒ is the onset temperature of Z-to-E thermal reverse isomerization and ΔHᵢₛₒ is the isomerization enthalpy. ΔHₜₒₜₐₗ is the total thermal energy released by the photo-triggered crystallization, calculated as the sum of ΔHᵢₛₒ and the crystallization enthalpy (ΔH_{c}) of E-isomer.

The spontaneous energy storage in the new compounds was demonstrated when they were placed in a greenhouse (FIG. 3B) where the UV-Vis range of sunlight transmitted through glass windows activates the E-to-Z switching and the reflected thermal radiation in the IR range facilitates the concomitant melting of the compounds (FIGS. 5A-B). This was a stand-alone setup without any electrically-powdered light sources such as arc lamps or LEDs, which simultaneously harnessed solar photons and solar thermal energy. FIG. 3C illustrates the energy storage process in which the initial crystalline sample (E isomer) melts and isomerizes under the filtered sunlight. A commercial band-pass filter was used to allow for the transmission of light that selectively promotes E-to-Z switching, and the elevated temperature in the greenhouse assists the latent heat storage. The experiments were conducted in daylight when ambient temperature ranges from 25° C. to 33° C. (Table 3).

In order to achieve an effective E-to-Z switching via the selective activation of n-π* band of E isomer, a variety of band-pass filters (BPF, FIGS. 3D-F) that were placed over the samples were tested. The corresponding transmission spectra of the BPFs displayed various widths of transmitted wavelengths (FIG. 3G-H): BPFs 1-4 had narrower widths compared to BPFs 5-7 that were common colored transparency films. The comparative optical images of compound 1 film before and after the BPF 4-filtered solar irradiation in the greenhouse (FIGS. 3I-L) demonstrate the clear morphological and color changes associated with the isomerization. A control experiment of photo-switching azobenzene and arylazopyrazole compounds (FIG. 1D) using a UV BPF was unsuccessful under a comparable greenhouse condition due to the lower UV irradiance in natural solar spectrum (Table 3).

TABLE 3
Outdoor Ambient Temperature and Wind Conditions
for Each Greenhouse Isomerization Experiment

| Ambient | Wind Speed | Successful | Unsuccessful |
|---|---|---|---|
| Temperature (° C.) | (mph) | Conversion | Conversion |
| 33 | 9 | 1 | — |
| 33 | 12 | 1 | — |
| 27 | 8 | 1 | — |
| 32 | 11 | 1, 2, 5 | 4 ^{a} |
| 25 | 17 | 1, 5 | 2 ^{b} |
| 28 | 12 | 1, 2, 5 | — |
| 9 | 7 | — | Azobenzene-ester ^{c} |
| | | | 4pzMe-ester ^{c} |
| 14 | 14 | — | Azobenzene-ester ^{c} |
| | | | 4pzMe-ester ^{c} |
| 8 | 11 | 3 ^{d} | Azobenzene-ester ^{d} |
| | | | 4pzMe-ester ^{d} |

^{a} A film of crystalline 4 was placed in the greenhouse covered with a red flexible filter. The film remained crystalline after 5 hours of solar irradiation.
^{b} A film of crystalline 2 was placed in the greenhouse covered with a 590 nm bandpass filter. The film remained crystalline after 5 hours of solar irradiation.
^{c} A film of crystalline E azobenzene tridecanoate ester and a film of 4pzMe-ester were placed in the greenhouse covered with a 360 nm bandpass filter. Both films remained crystalline after 5 hours of solar irradiation.
^{d} Auxiliary heating was provided by a hot plate put under the greenhouse (T set to 28° C.) during the solar irradiation to simulate the warmer environment of previous experiments.

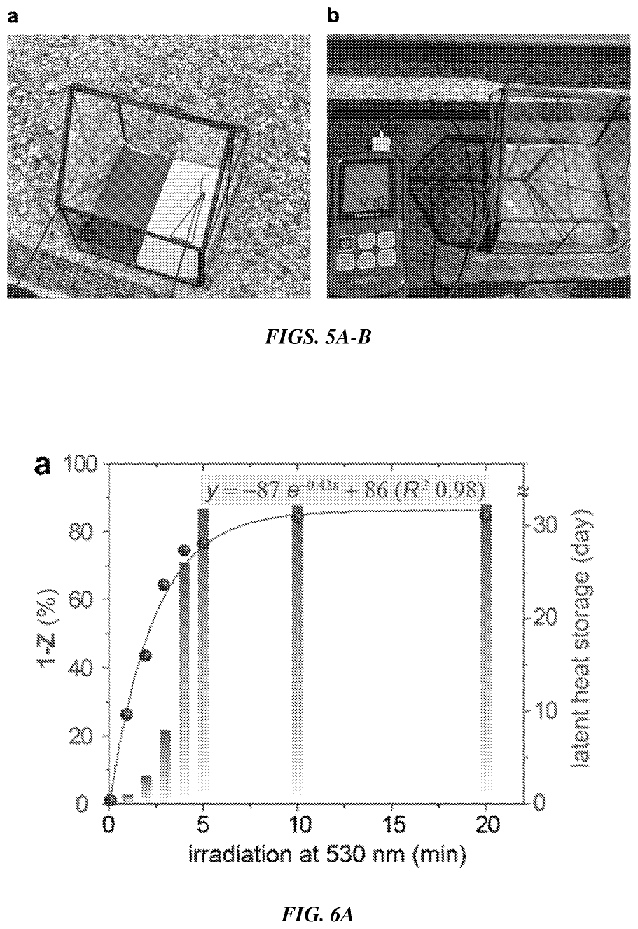

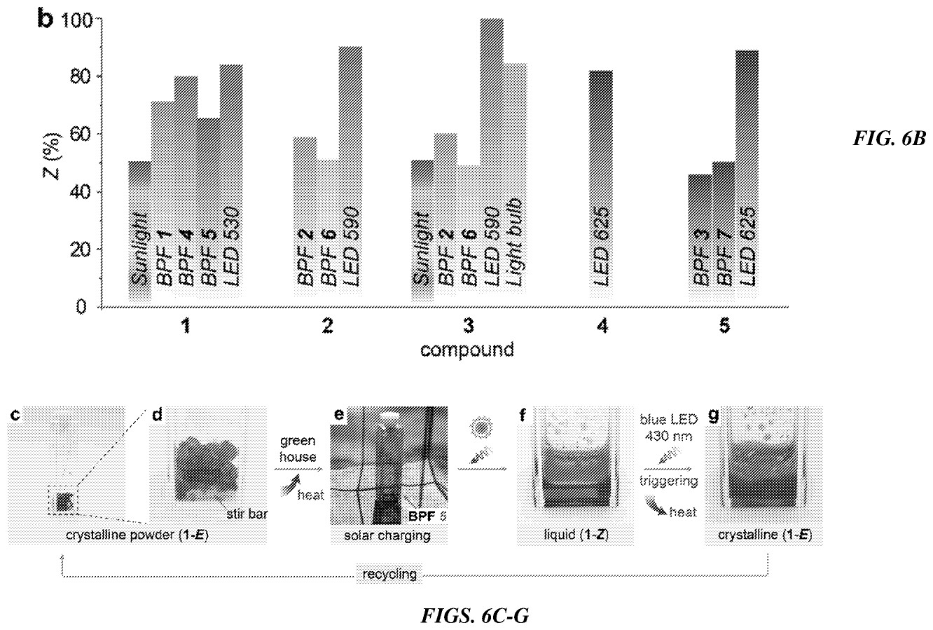

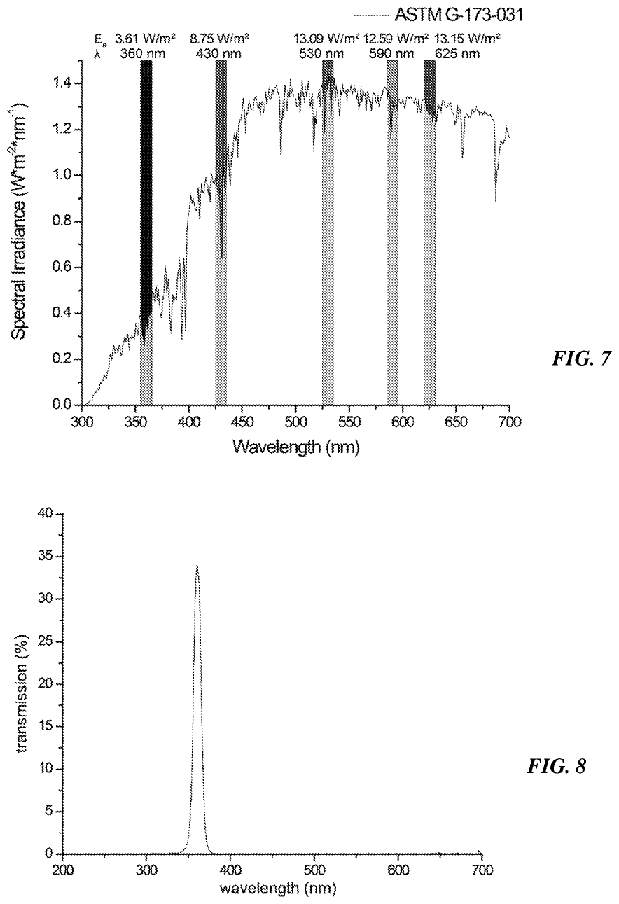

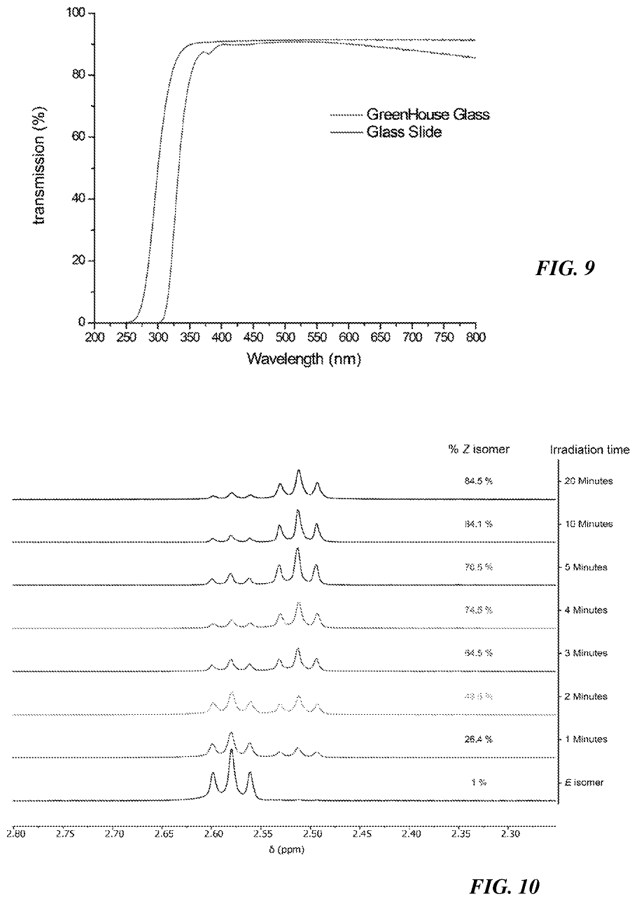

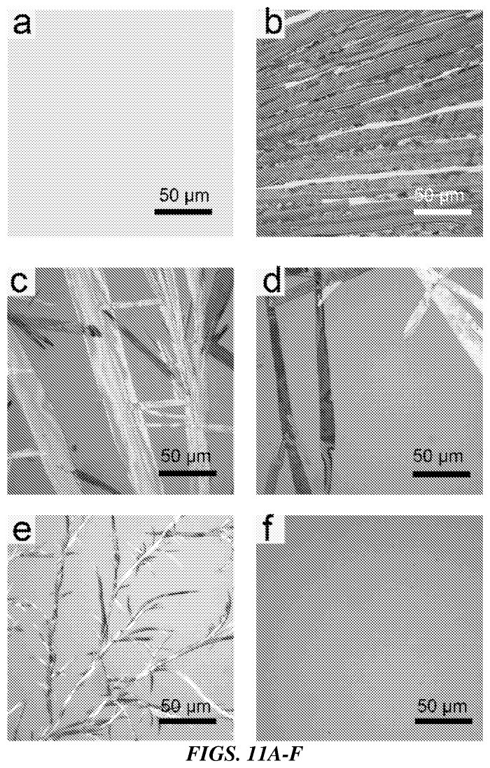

FIG. 6A depicts the increasing extent of E-to-Z isomerization of compound 1 by the varied irradiation time at 530 nm. The light intensity of 530 nm LED used for the experiment (12 mW) was ˜3.3 times higher than the filtered sunlight through BPF 1 (estimated to be 3.6 mW, see FIGS. 7-9). % Z in the film sample increased exponentially, reaching the saturation in 10 min of irradiation (FIG. 10). Thus-formed liquid films containing various % Z isomers were monitored closely to measure the stability of liquid phase before crystallization, or the latent heat storage time. The short-irradiated films (1, 2, and 3 min) containing less than 70% Z isomer crystallized in 1, 3, and 8 days, respectively. Remarkably, other samples that were irradiated for 5 min or longer accumulated more than 70% Z isomer, and their liquid phase was preserved for at least a month in dark, demonstrating the exceptionally long-term storage of latent heat (FIGS. 11A-F).

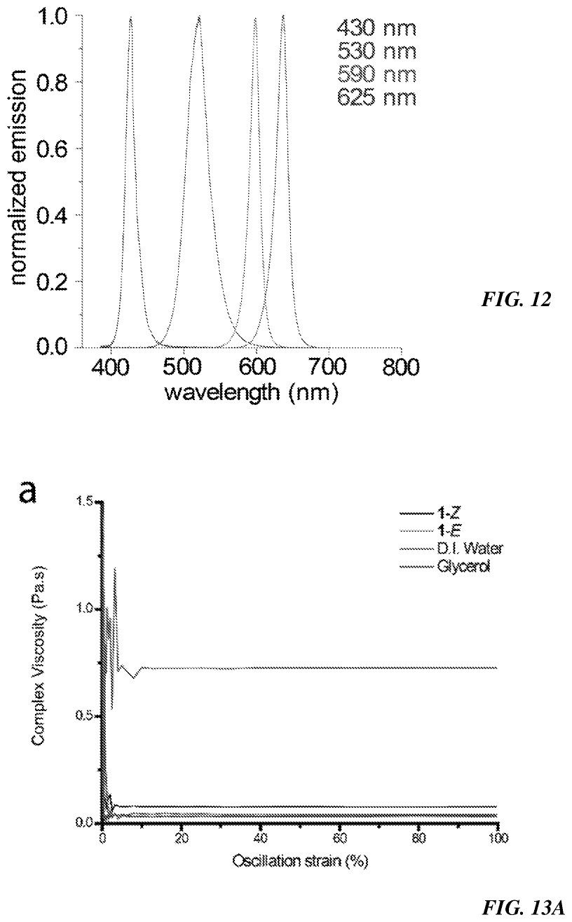

FIG. 6B shows the % Z acquired for each compound by the direct sunlight, filtered sunlight, LED, and fluorescent light irradiation. The experiments were conducted in a greenhouse for direct or filtered sunlight irradiation or under an ambient condition for the fluorescent light bulb illumination. The LED experiments were performed at temperatures a few degrees above the melting point of each E isomer to achieve the maximum % Z: 50° C. for compound 1, 60° C. for compound₂, and 80° C. for compound 4 (Table 4). Due to the high melting point and crystallinity of compound 4, its conversion to Z isomer was negligible at room temperature or an elevated temperature in a greenhouse under direct or filtered sunlight. The photo-irradiation experiments on compounds 3 and 5 were performed at room temperature in a supercooled liquid (3) or liquid (5) phase. Interestingly, a fluorescent light bulb was more effective at isomerizing compound 3 than the direct of filtered sunlight. The complete experimental data on E-to-Z and Z-to-E conversion in solutions as well as condensed phases are summarized in Tables 4 and 5. The LED emission profiles in FIG. 12 displayed comparable widths to those of filtered sunlight (FIG. 3G).

TABLE 4
Percentage of the Z or E Isomers Obtained
at PSS Under LED Irradiation

| Compound | 1 | 2 | 3 | 4 | 5 |
|---|---|---|---|---|---|
| % Z isomer solution state | 91%^{a} | 89%^{b} | 87%^{b} | 88%^{c} | 88%^{c} |
| | 74%^{e} | 76%^{e} | 70%^{e} | 70%^{e} | 67%^{e} |
| % Z isomer condensed state | 84%^{a} | 90%^{b} | 98%^{b} | 82%^{c} | 89%^{c} |
| | | | 83%^{e} | | |
| % E isomer solution state | 80%^{d} | 84%^{d} | 85%^{d} | 90%^{d} | 89%^{d} |
| % E isomer condensed state | 91%^{d} | 83%^{d} | 88%^{d} | 92%^{d} | 90%^{d} |

The 1-E, 2-E, and 4-E films were irradiated at 50, 60, and 80° C., respectively. The liquid 5-E and supercooled 3-E films were irradiated at RT.
Irradiation at
^{a}530 nm,
^{b}590 nm,
^{c}625 nm,
^{d}430 nm, and
^{e}by a fluorescence light bulb.

TABLE 5
Percentage of Z-Isomers Acquired by the Solar Irradiation
Through Bandpass Filters (BPF) or Direct Sunlight (N/A)

| Filter | 1 | 2 | 3 | 5 |
|---|---|---|---|---|
| BFP1 | 70% | 58% | | |
| BFP4 | 81% | | | |
| BFP5 | 66% | | | |
| BFP2 | | 59% | 60% | 44% |
| BFP6 | | 52% | 49% | |
| BFP3 | | | | 46% |
| BFP7 | | | | 50% |
| N/A | 51% | | 52% | |

Compound 1 achieved a high level of % Z in thin films under the filtered sunlight through BPF 4 (81%), similar to the maximum % Z acquired by 530 nm LED irradiation (84%), despite ˜2 times lower total irradiance of filtered sunlight compared to LED (FIG. 7). In contrast, compounds 2, 3, and 5 showed a larger difference of % Z between the sunlight-irradiated and LED-activated samples. This is primarily caused by the low absorption coefficient of E isomers at 590 nm and 625 nm (FIG. 2), which requires a strong light source for achieving high % Z within a reasonable timeframe (e.g. hours). In the pursuit of achieving a higher % Z, compound₂ was irradiated under sunlight through BPF 1 (530 nm), but 58% conversion was obtained as nearly identical to the results of BPF 2 and 6 (Table 5).

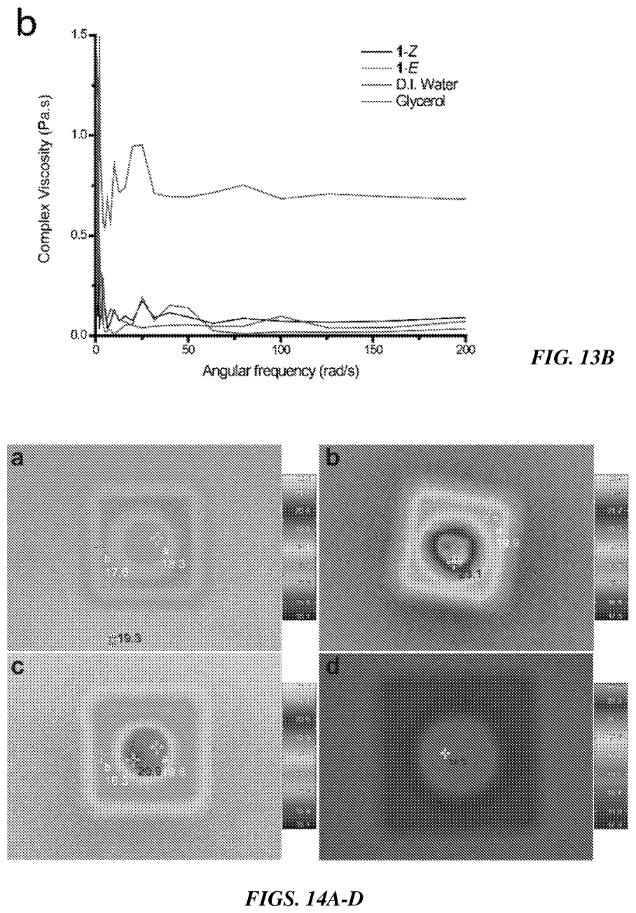

The crystal-to-liquid phase transition at a larger scale (160 mg) than the thin film condition was demonstrated by a stirred sunlight irradiation of 1-E in the greenhouse through BPF 5 which provided a broad transmission of 450-600 nm (FIGS. 6C-E). The conversion was successful, resulting in 72% Z within 5 hours of exposure to sunlight. The obtained liquid phase showed a similar viscosity to water rather than glycerol, as measured by strain sweep and frequency sweep rheometry (FIGS. 13A-B). The low viscosity of the organic liquid opens up new opportunities in achieving a large-quantity solar energy storage in such materials by employing a flow system, as previously demonstrated on solution-state norbornadiene (Wang et al., “Macroscopic Heat Release in a Molecular Solar Thermal Energy Storage System,” Energ. Environ. Sci. 12:187-193 (2019), which is hereby incorporated by reference in its entirety) and (fulvalene)diruthenium (Moth-Poulsen et al., “Molecular Solar Thermal (MOST) Energy Storage and Release System,” Energ. Environ. Sci. 5:8534-8537 (2012), which is hereby incorporated by reference in its entirety) MOST compounds. The viscosity of molten 1-E was measured to be similar to that of liquid 1-Z, suggesting that sunlight-driven E-Z switching could be achieved in the liquid flow system at elevated temperatures. The acquired liquid 1-Z was then triggered by 20 430 nm blue LED to immediately crystallize and release heat (FIG. 6F-G). The crystallized material containing 91% E isomer after the heat release was recycled for energy storage in the greenhouse.

This heat release process was successfully monitored by an IR thermal camera (FIGS. 14A-D). The immediate heat release from the liquid 1-Z was observed during the crystallization upon the exposure to 430 nm, as the temperature of the sample rises up to 23° C. which was consistently 2-3° C. higher than the surroundings. After the complete crystallization, the temperature dropped to 19-20° C., as the heat rapidly dissipated to the cooler environment. The control experiment in which the solid 1-E was irradiated by 430 nm LED showed no change of temperature, confirming that the appreciable temperature change observed from 1-Z is primarily the result of crystallization rather than photo-thermal effect. The mechanical stirring did not contribute to any measurable temperature change, as a constantly low temperature of stirred liquid 1-Z was detected before 430 nm irradiation (FIGS. 14A-D).

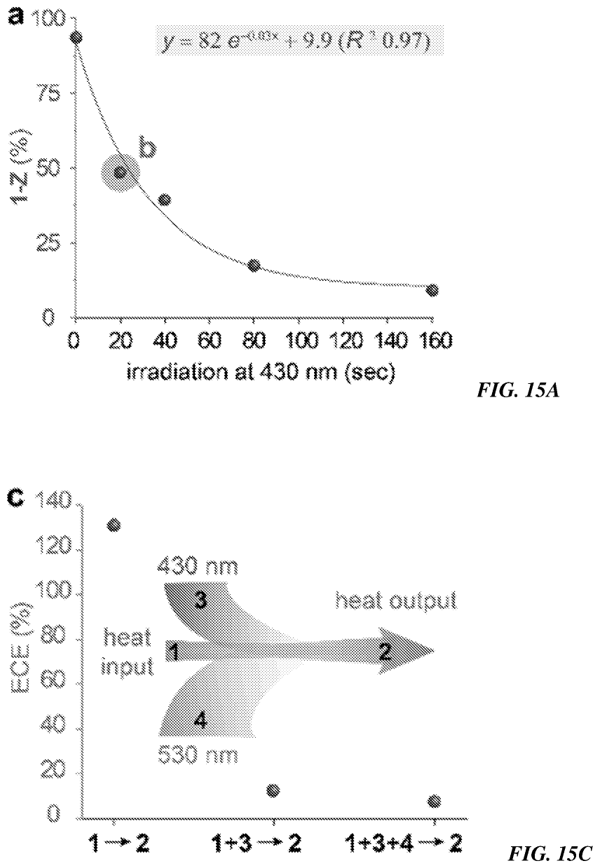

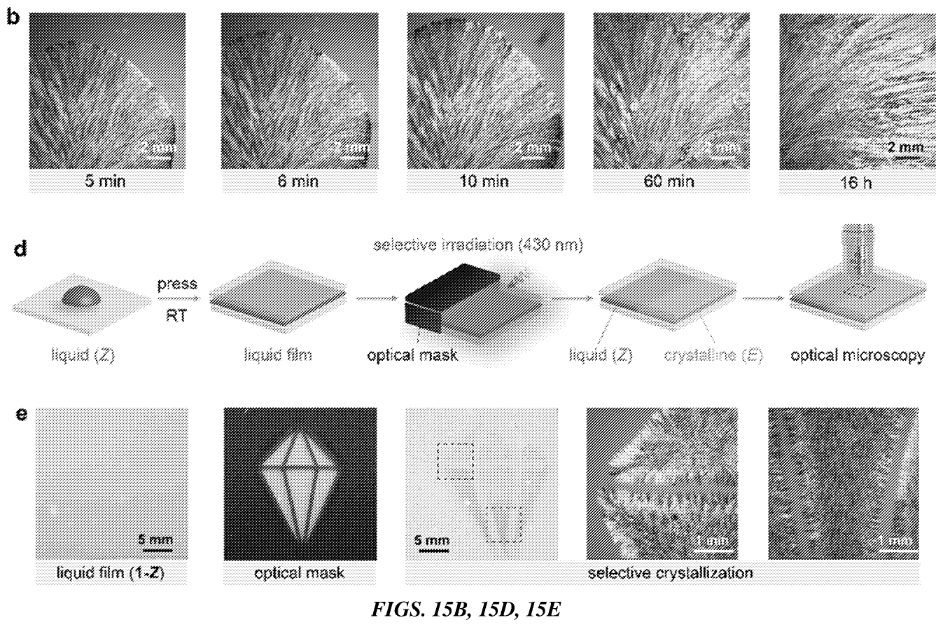

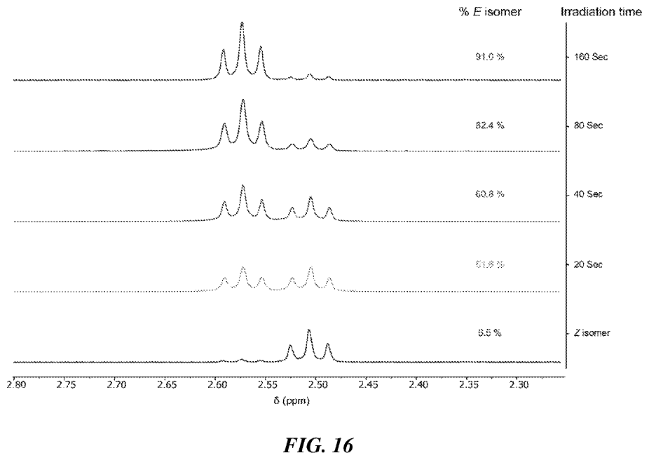

The crystallization of liquid Z samples and the consequent heat release were effectively triggered by the irradiation of 430 nm LED. The n-π* band of all Z isomers (compounds 1-5) peaked at 424±6 nm, thus the Z-to-E reverse isomerization occurred fast under 430 nm irradiation. FIG. 15A shows a rapid exponential decrease of % Z in the liquid films of compound 1 upon 430 nm exposure. Even within 20 sec of irradiation, over 50% conversion to E isomer was obtained, and after 80 sec the % Z drops below 20% (FIG. 16) inducing an immediate and complete crystallization. Since the crystallization was very rapid, it was challenging to monitor the nucleation and propagation processes. Thus a sample (2.5 cm by 2.5 cm film) was selected that was irradiated only for 20 sec to observe the growth of crystals under an optical microscope (FIG. 15B). The partial crystallization is observed after 5 min past the initial irradiation, which reflects the slow assembly of E isomers in the liquid sample still containing ˜50% Z isomers. The initial nucleation site propagated slowly over 60 min due to the low concentration of E isomers. After 16 hours, the crystalline phase became denser and thicker, while there was still liquid phase surrounding the crystals. This corroborates the long-term stability of Z liquid in dark (FIG. 6A) and the high thermal reversion temperature for Z-to-E isomerization (onset Tᵢₛₒ˜114° C., FIG. 4, Table 2).

Based on the measurement of the heat absorption, heat release, and photon absorption needed for isomerization, the energy conversion efficiency (ECE, %) of the optically-controlled energy storage system was calculated. The relative energy input and output are shown in FIG. 15C for compound 1 as an example. The melting enthalpy for 1-E was obtained by integrating the DSC endothermic peak of melting transition (i.e. heat input). The heat output was calculated as the sum of the crystallization enthalpy of 1-E and the isomerization enthalpy released from Z-to-E reversion. The thermal energy storage efficiency, the ratio of heat output and input, thus exceeds 100% due to the additional isomerization enthalpy released during the optically-triggered crystallization (i.e. 131%).

The photon energy required to trigger the crystallization was calculated by applying the quantum yield of Z-to-E switching. Due to the suboptimal quantum yield of o-fluoroazobenzene (Φ_{Z-E}=0.49) (Knie et al., “Ortho-Fluoroazobenzenes: Visible Light Switches with Very Long-Lived Z Isomers,” Chem. Eur. 1 20:16492-16501 (2014), which is hereby incorporated by reference in its entirety), significant photon absorption was required for inducing crystallization. Therefore, the ECE, the ratio of heat output and the total photon and heat input, decreased to ˜13%. Furthermore, considering the incident photon energy for E-to-Z conversion, the total ECE dropped to ˜6% due to the low quantum yield of isomerization (Φ_{E-Z}=0.3) (Knie et al., “Ortho-Fluoroazobenzenes: Visible Light Switches with Very Long-Lived Z Isomers,” Chem. Eur. J. 20:16492-16501 (2014), which is hereby incorporated by reference in its entirety). If considering an incomplete E-to-Z or Z-to-E switching during the filtered sunlight irradiation or short 430 nm exposure, the photon energy consumption was reduced, leading to the slightly increased total ECE up to >8% (Example 3 above).

The photo-induced crystallization process was further manifested by the selective exposure of the Z isomer in liquid phase to 430 nm LED through an optical mask (FIG. 15D). The interface between the exposed and covered area was investigated by optical microscopy to confirm that the crystallization is solely induced by photo-irradiation rather than nucleation from any artifact. FIG. 15E clearly visualizes the selective irradiation process and the interface between the generated crystalline phase and intact liquid phase. The intricate crystal pattern was preserved for at least a month without any visible propagation of the crystals, confirming that only E isomers are able to crystallize, consistent with the long-term stability of Z liquid phase (FIG. 6A). Therefore, the crystal propagation observed in FIG. 15B implies the delayed assembly of E isomers that are intermixed with Z isomers (˜50%) in the film after the brief, uniform exposure to blue light.

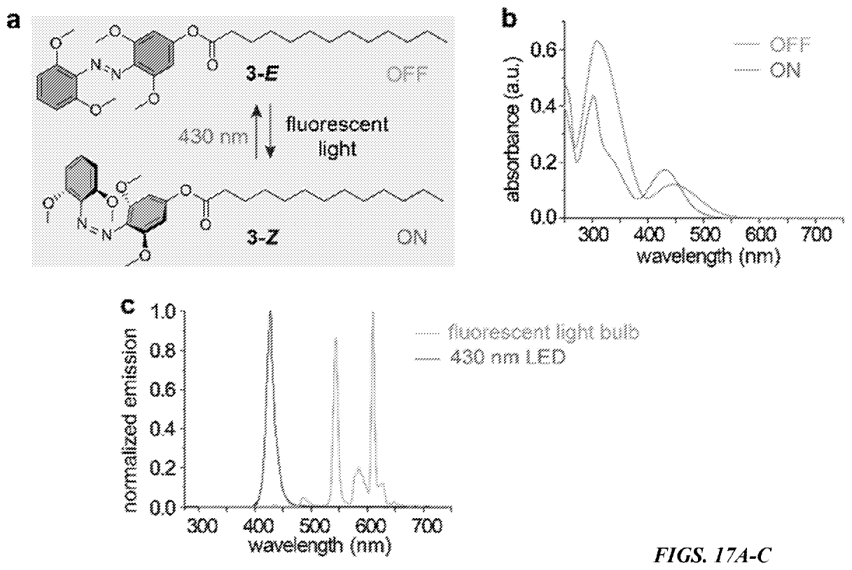

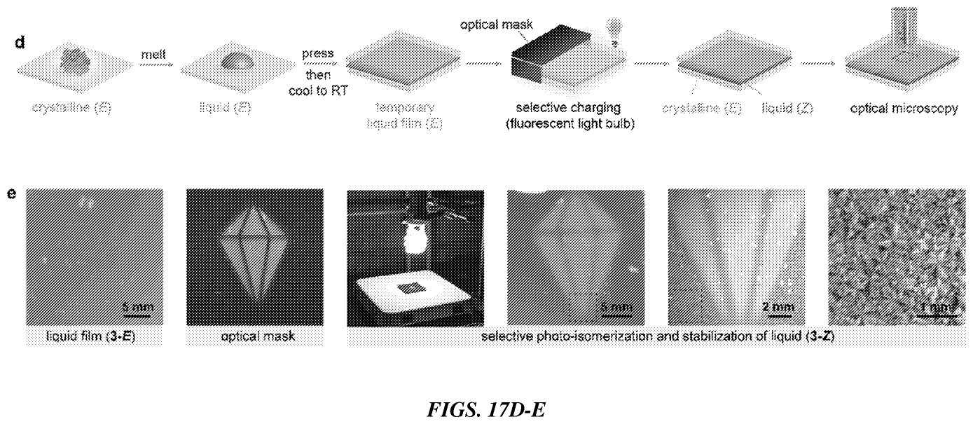

Surprisingly, all compounds 1-5 were able to undergo E-to-Z isomerization by the exposure to a regular fluorescent light bulb (Table 4), which suggests a potential to develop energy storage materials that not only harness sunlight but also indoor ambient light. Compound 3 was selected to demonstrate the fluorescent light-induced E-to-Z switching (FIG. 17A) and phase transition, since compound 3 showed a considerably larger % Z acquired by fluorescent light than filtered sunlight irradiation (FIG. 6B). Due to the red-shifted n-π* band of 3-E (FIG. 17B), the fluorescent light bulb emission centered around 550 nm and 610 nm (FIG. 17C) effectively promoted E-to-Z conversion. The reversion was achieved by 430 nm irradiation, which had a negligible overlap with the bulb emission profile.

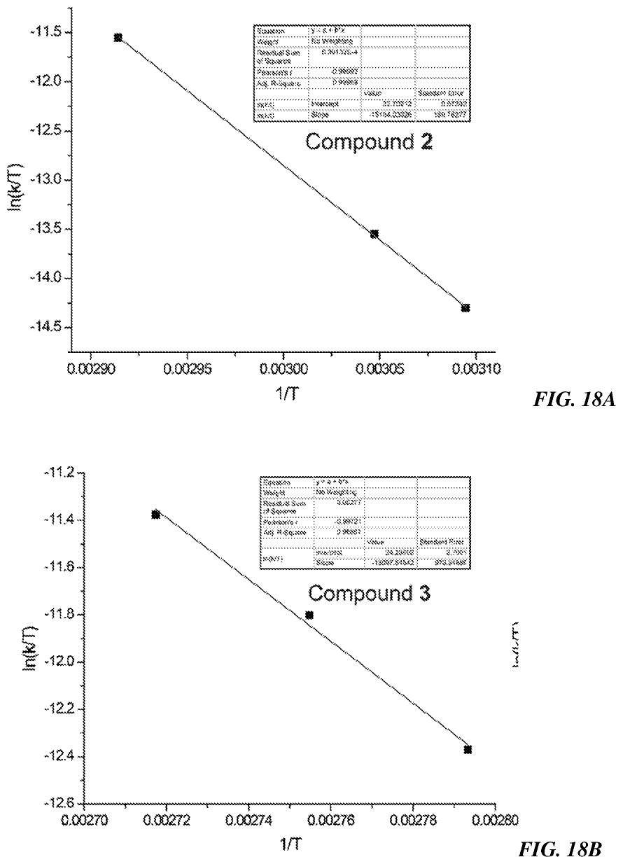

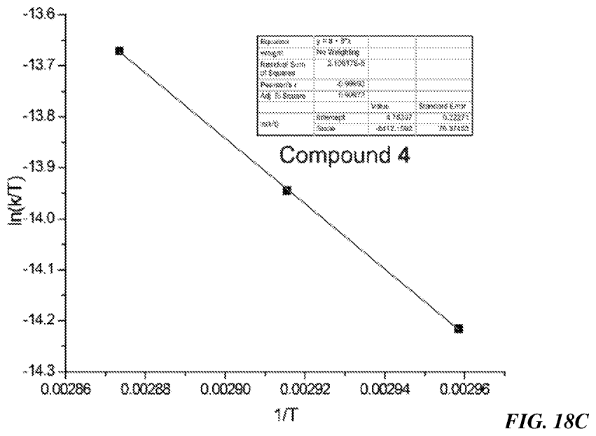

The experimental procedure is illustrated in FIG. 17D. Compound 3-E formed a supercooled liquid at room temperature upon pre-melting and the liquid film was exposed to fluorescent light through an optical mask. 3-Z isomer was generated by the selective irradiation and formed a stable liquid phase (a thermal half-life of 3-Z exceeds 1.5 years at room temperature, see FIGS. 18A-C and Table 6), while the supercooled 3-E gradually cold-crystallized during the 90 min experiment. The optical microscope images in FIG. 17E show a clear contrast between the liquid Z isomers and crystalline E isomers. This shows the possibility of utilizing compound 3 among others as a PCM that harnesses photons from indoor fluorescent light and release latent heat upon triggering by a blue LED.

TABLE 6
Summary of Half-Lives of Z Azobenzene Derivatives at 298K

| | 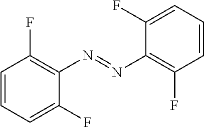 [SMILES: Fc1cccc(F)c1/N=N/c1c(F)cccc1F] | 2 | 3 | 4 |
|---|---|---|---|---|
| t^{1/2}(298K) | 700 d* | 136 d | 589 d | 31 d |

*Blèger et al., “o-Fluoroazobenzenes as Readily Synthesized Photoswitches Offering Nearly Quantitative Two-Way Isomerization with Visible Light,” J. Am. Chem. Soc. 134:20597-20600 (2012), which is hereby incorporated by reference in its entirety.

The newly designed compounds underwent sunlight-driven E-to-Z isomerization and simultaneous solid-to-liquid transition, storing both isomerization energy and latent heat in the liquid phase, without the need for high-intensity UV sources. The liquid phase containing maximum % Z was preserved for at least a month in the absence of crystallization, exhibiting a remarkable stability and the long-term storage of thermal energy. The rapid release of the stored energy prompted by a blue LED irradiation was clearly monitored by an IR thermal camera. The compounds also revealed the potential to recycle the photon energy from indoor fluorescent light illumination. This successful demonstrations signify the utility of photo-responsive organic materials for solar energy harvesting, as a complementary tool to photovoltaics and photocatalysis.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A compound of Formula (I): 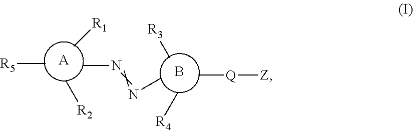
wherein [symbol]
and [symbol] are independently aryl or heteroaryl 5- or 6-membered rings;
R¹, R², R³, and R⁴ are each in an ortho position to the azo group, and each is independently selected from halogen, C₁ to C₆ alkoxy, C₁ to C₆ alkylthio, halomethyl, dihalomethyl, trihalomethyl, and di(C1 to C6 alkyl)amino;
R⁵ is H, C₁ to C₆ alkyl, C₁ to C₆ alkoxy, halogen, trihalomethyl, or cyano;
Q is X is —OC(O)—, —OC(S)—, —NHC(O), —SC(O)—, —NHC(S)—, —NHC(O)NH—, —NHC(S)NH—, —C(O)NHC(O)—; and
Z is a C₆ to C₁₈ straight- or branched-chain hydrocarbon.

2. The compound according to claim 1 wherein the compound of Formula (I) has the structure of Formula (Ia):

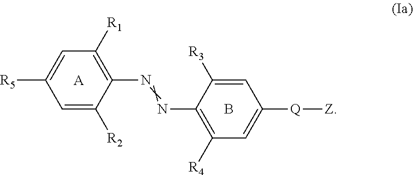

3. The compound according to claim 1, wherein [symbol] and [symbol] are independently selected from the group consisting of phenyl, oxazolyl, isoxazolyl, thiazolyl, and isothiazolyl.

4. The compound according to claim 3, wherein [symbol] and [symbol] are the same.

5. (canceled)

6. The compound according to claim 1, wherein each of R¹, R², R³, and R⁴ is a halogen selected from F, Cl, and Br.

7. The compound according to claim 1, wherein
each of R¹, R², R³, and R⁴ is the same, and is F, Cl, methoxy, or ethoxy; or
each of R¹, R², R³, and R⁴ are not all the same, and two of R¹, R², R³, and R⁴ are F, and the other two of R¹, R², R³, and R⁴ are Cl.

8. (canceled)

9. (canceled)

10. (canceled)

11. (canceled)

12. (canceled)

13. The compound according to claim 1, wherein Z is a C₈ to C₃₀ straight or branched-chain, saturated hydrocarbon, and Q is —OC(O)— or —OC(S)—.

14. (canceled)

15. (canceled)

16. (canceled)

17. The compound according to claim 1, wherein the compound is selected from the group of:

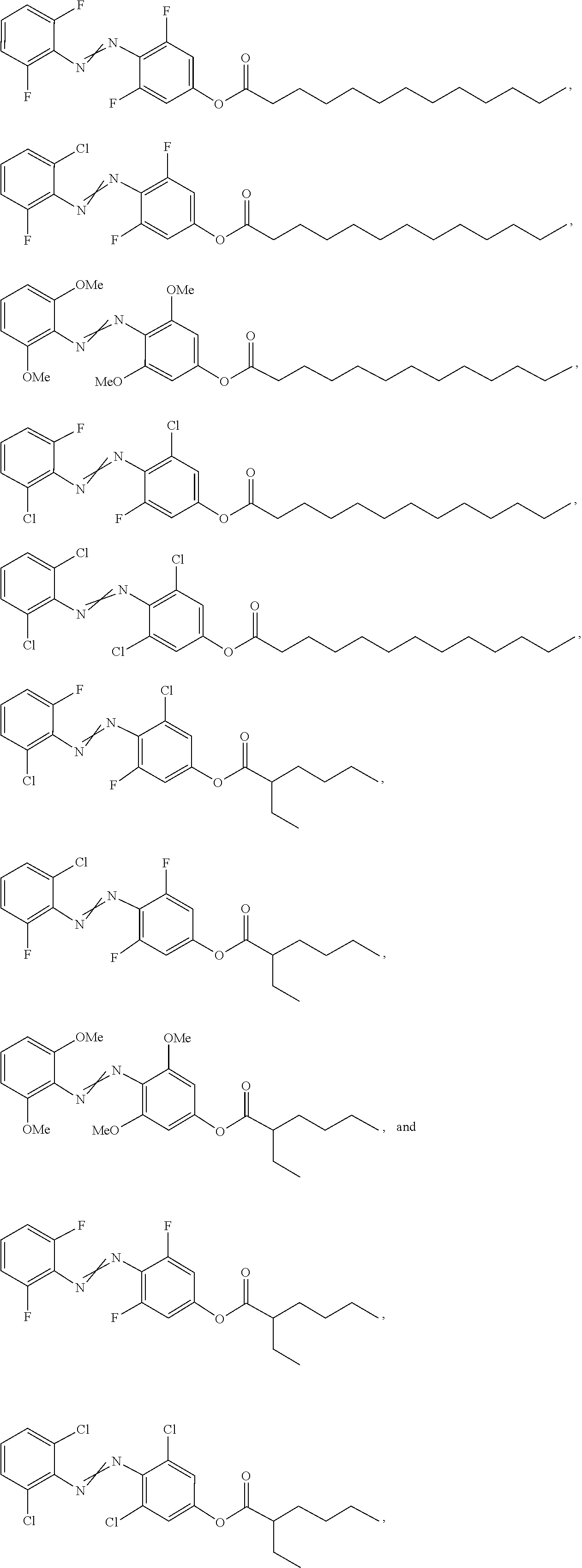

18. (canceled)

19. (canceled)

20. (canceled)

21. A composition comprising one or more compounds of Formula (I) according to claim 1.

22. (canceled)

23. The composition according to claim 21, wherein the composition further comprises an organic phase-change material in which the compound of Formula (I) is dispersed while in the liquid state.

24. (canceled)

25. (canceled)

26. The composition according to claim 23, wherein the organic phase-change material is present in the composition in an amount of about 30 to about 70 weight percent (based on the total weight of the composition).

27. (canceled)

28. The composition according to claim 21, wherein the composition further comprises a polymer solution or film in which the compound of Formula (I) is dispersed.

29. (canceled)

30. (canceled)

31. (canceled)

32. (canceled)

33. (canceled)

34. A composite structure comprising a porous structural component and a compound according to claim 1.

35. (canceled)

36. A composite structure comprising an enclosure that comprises an optically transparent wall and defines a compartment comprising a compound according to claim 1.

37. (canceled)

38. A thermal storage system comprising a composite structure according to claim 36.

39. The thermal storage system according to claim 38 further comprising a light source that emits a wavelength of light suitable to induce an isomeric phase-change of the compound or composition of the composite structure, a switch that controls operation of the light source, and either a power source or a connector adapted for connecting the thermal storage system to a power source.

40. (canceled)

41. The thermal storage system according to claim 39, wherein a plurality of composition structures and a plurality of light sources are present.

42. (canceled)

43. (canceled)

44. (canceled)

45. (canceled)

46. (canceled)

47. A process for preparation of a compound of Formula (I) as defined in claim 16, said process comprising: providing a compound of Formula (II): 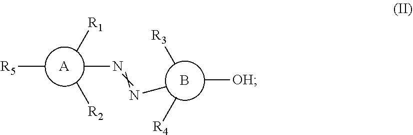
and
reacting the compound of formula (II) with 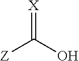
under conditions effective to form the compound according to formula (I).

48. (canceled)

49. (canceled)

50. (canceled)

51. (canceled)

52. A method of storing energy comprising: providing an energy storage device comprising one or more compounds of Formula (I) according to claim 1, whereby the one or compounds of Formula (I) is present as an E-isomer; activating the compound of Formula (I) to produce a Z-isomer thereof; and storing the Z-isomer of the one or more compounds of Formula (I) for a period of time.

53. The method of claim 52, wherein said activating involves exposing to the energy storage device to sunlight or light having a wavelength in the visible spectrum.

54. The method of claim 52 further comprising: inducing the Z-isomer of the one or more compounds of Formula (I) to isomerize back to E-isomer state, thereby releasing energy stored during said activating.

55. (canceled)

56. (canceled)

57. (canceled)

58. (canceled)

59. (canceled)

60. (canceled)

61. (canceled)

62. The method of claim 54, comprising repeated cycles of said activating, storing, and inducing.
